(19) United States
(12) Patent Application Publication
(10) Pub. No.: US 2021/0255746 A1
(43) Pub. Date: Aug. 19, 2021

(54) APPLICATION CONTROL METHOD AND ELECTRONIC DEVICE

(71) Applicant: HUAWEI TECHNOLOGIES CO., LTD., Shenzhen (CN)

(72) Inventors: Jinyan HU, Shanghai (CN); Linfang JIN, Dongguan (CN); Siyang LI, Shanghai (CN)

(21) Appl. No.: 17/261,467

(22) PCT Filed: Jul. 20, 2018
(86) PCT No.: PCT/CN2018/096529

§ 371 Date: Jan. 19, 2021

(51) Int. Cl. G06F 3/0482; G06F 3/0481; G06F 3/0488; H04N 5/232; G06F 1/3203; G06F 1/20

(52) U.S. Cl. CPC G06F 3/0482; G06F 3/04817; G06F 3/0488; H04L 51/22; H04N 5/232939; G06F 1/3203; G06F 1/206; H04N 5/232935

(57) ABSTRACT

An application control method and an electronic device are provided. The method includes: The electronic device displays a first user interface of a first application, where the first user interface has N graphical controls; and the electronic device updates the first user interface if a temperature of the electronic device is less than or equal to a first preset temperature, so that an updated first user interface has less than N graphical controls, where N is a natural number greater than 1. In this manner, when the electronic device has a relatively low temperature, a user may be restricted from using some functions of an application.

### TECHNICAL FIELD

This application relates to the field of terminal technologies, and in particular, to an application control method and an electronic device.

### BACKGROUND

With the advancement of science and technology, electronic devices are becoming increasingly popular. The electronic device includes components, and the component usually has a normal temperature range. The component can work normally at a temperature within the normal temperature range, and normal operation of the component is affected at an extremely low or extremely high temperature. Taking a mobile phone as an example, an internal resistance of a battery of the mobile phone increases at an extremely low temperature. The battery of the mobile phone generates fewer currents after the internal resistance of the battery of the mobile phone increases. If a component in the mobile phone consumes a relatively large current when working, the mobile phone will be powered off due to fast power reduction. As a result, use efficiency of an electronic device such as a mobile phone is greatly reduced.

### SUMMARY

To resolve the foregoing technical problem, this application provides an application control method and an electronic device, to reduce a case in which the electronic device is powered off due to fast power reduction at a low temperature, thereby improving user experience.

According to a first aspect, an embodiment of this application provides an application control method. The method is applicable to an electronic device. For example, the electronic device is a mobile phone or an iPad. The method includes: the electronic device displays a first user interface of a first application, where the first user interface has N graphical controls; and the electronic device updates the first user interface if a temperature of the electronic device is less than or equal to a first preset temperature, so that an updated first user interface has less than N graphical controls, where N is a natural number greater than 1.

In this embodiment of this application, a user interface that is of an application and that is displayed on a display screen may change when the electronic device has a relatively low temperature. In other words, the user interface displayed on the display screen may be updated when the electronic device has a relatively low temperature, so that an updated user interface has fewer graphical controls. In this manner, when the electronic device has a relatively low temperature, a user may be restricted from using some functions of an application (for example, the user cannot use a graphical control that disappears in an updated user interface). In this manner, power consumption of the electronic device is reduced as much as possible, to reduce a case in which the electronic device is powered off due to fast power reduction, thereby improving user experience.

In a possible design, the updated first user interface has M graphical controls, and when one of the M graphical controls is triggered, the electronic device performs a function corresponding to the graphical control, where M is a natural number greater than or equal to 1 and less than N; and before the electronic device updates the first user interface, the electronic device displays a second user interface of the first application if the temperature of the electronic device is greater than the first preset temperature and less than or equal to a second preset temperature, where the second user interface has the N graphical controls, a luminance value of each of N−M graphical controls other than the M graphical controls in the N graphical controls is a first luminance value, the first luminance value is less than a second luminance value, and the second luminance value is a luminance value of each of the N−M graphical controls in the first user interface.

In this embodiment of this application, some graphical controls (the N−M graphical controls) in the first user interface on the display screen of the electronic device gradually disappear as the temperature of the electronic device gradually decreases, and these graphical controls in the first user interface completely disappear when the temperature of the electronic device decreases to be less than or equal to the first preset temperature. In this manner, when the electronic device has a relatively low temperature, the user may be restricted from using some functions of an application (for example, the user cannot use a graphical control that disappears in an updated user interface). In this manner, power consumption of the electronic device is reduced as much as possible, to reduce a case in which the electronic device is powered off due to fast power reduction, thereby improving user experience.

In a possible design, the updated first user interface has M graphical controls, and when one of the M graphical controls is triggered, the electronic device performs a function corresponding to the graphical control, where M is a natural number greater than or equal to 1 and less than N; and after the electronic device updates the first user interface, the electronic device is further configured to display a second user interface of the first application when the temperature of the electronic device is greater than the first preset temperature and less than or equal to a second preset temperature, where the second user interface has the N graphical controls, a first luminance value of N−M graphical controls other than the M graphical controls in the N graphical controls is less than a second luminance value, and the second luminance value is a luminance value of each of the N−M graphical controls in the first user interface; and the electronic device displays the first user interface when the temperature of the electronic device is greater than the second preset temperature.

In this embodiment of this application, some graphical controls (the N−M graphical controls) in the first user interface on the display screen of the electronic device gradually appear as the temperature of the electronic device gradually rises, and these graphical controls in the first user interface completely recover when the temperature of the electronic device is greater than the second preset temperature. In this manner, the electronic device may gradually recover a forbidden function in an application when the temperature of the electronic device rises. In this manner, the electronic device may flexibly restrict or enable some functions of an application based on a temperature change, so that power consumption of the electronic device is flexibly controlled based on the temperature change, to prevent as much as possible normal working of the electronic device from being affected due to an extremely low or extremely high temperature of the electronic device, thereby improving user experience.

In a possible design, the electronic device displays the updated first user interface instead of the first user interface when the temperature of the electronic device is greater than or equal to a third preset temperature, where the third preset temperature is greater than the second preset temperature.

In this embodiment of this application, the electronic device displays the updated first user interface instead of the first user interface when the electronic device has a relatively high temperature, where the updated first user interface has fewer graphical controls. In this manner, when the electronic device has a relatively high temperature, the user may also be restricted from using some functions of an application (for example, the user cannot use a graphical control that disappears in an updated user interface). In this manner, power consumption of the electronic device is reduced as much as possible, to prevent the temperature of the electronic device from continuously rising, thereby improving user experience.

In a possible design, when the temperature of the electronic device is greater than or equal to a third preset temperature, the electronic device does not display the first user interface anymore, and disables the first application, where the third preset temperature is greater than the second preset temperature; and the electronic device displays a third user interface, where the third user interface is a display interface of a currently running second application.

In this embodiment of this application, when the electronic device has a relatively high temperature, the electronic device disables the first application, and displays the third user interface of the second application. For example, the second application may be an application whose power consumption is lower than that of the first application. In this manner, when the electronic device has a relatively low temperature, the first application with relatively high power consumption may be disabled, and the third user interface of the second application with relatively low power consumption may be displayed, so that power consumption of the electronic device is reduced as much as possible, to prevent the temperature of the electronic device from continuously rising, thereby improving user experience.

In a possible design, when the first application is a camera application, the first user interface is a preview interface of the camera application, the preview interface has a graphical control of a portrait photographing mode, and an updated preview interface does not have the graphical control of the portrait mode.

In this embodiment of this application, when the preview interface of the camera application is displayed on the display screen of the electronic device, the graphical control of the portrait photographing mode in the preview interface disappears if the electronic device has a relatively low temperature. In this manner, when the electronic device has a relatively low temperature, the user is forbidden from using the portrait photographing mode in the camera application, so that power consumption of the electronic device is reduced as much as possible, to reduce a case in which the electronic device is powered off due to fast power reduction, thereby improving user experience.

In a possible design, when the first application is a chat application, the first user interface is a chat interface of the chat application, the chat interface has a video call graphical control, a voice call graphical control, and a photographing graphical control, and an updated chat interface does not have one or more of the video call graphical control, the voice call graphical control, and the photographing graphical control.

In this embodiment of this application, when the chat interface of the chat application is displayed on the display screen of the electronic device, some graphical controls (for example, the video call graphical control, the voice call graphical control, and the photographing graphical control) in the chat interface disappear if the electronic device has a relatively low temperature. In this manner, when the electronic device has a relatively low temperature, the user is forbidden from using the portrait photographing mode in the camera application, so that power consumption of the electronic device is reduced as much as possible, to reduce a case in which the electronic device is powered off due to fast power reduction, thereby improving user experience.

In a possible design, the electronic device displays an icon or a text in a status bar in response to the updating of the first user interface, where the icon or the text is used to indicate that the temperature of the electronic device is less than or equal to the first preset temperature.

In this embodiment of this application, the icon or the text is displayed in the status bar of the electronic device after or when the first user interface on the display screen of the electronic device is updated. The user may learn, based on the icon or the text, that the electronic device currently has a relatively low temperature, thereby improving user experience.

In a possible design, before the electronic device displays the updated first user interface, the electronic device determines that a current load amount is greater than a preset load amount.

Usually, when the electronic device has a relatively low temperature, if the electronic device currently has a relatively high load amount; in other words, the electronic device has relatively high power consumption, the electronic device is tended to be powered off due to fast power reduction. To resolve this problem, in this embodiment of this application, when the electronic device has a relatively low temperature, the electronic device displays the updated first user interface if the electronic device has a relatively high load amount. In this manner, the user is restricted from using some functions of the first application, so that power consumption of the electronic device is reduced as much as possible, to reduce a case in which the electronic device is powered off due to fast power reduction, thereby improving user experience.

According to a second aspect, an embodiment of this application provides an application control method. The method is applicable to an electronic device. For example, the electronic device is a mobile phone or an iPad. The method includes: the electronic device displays a home screen, where the home screen has N graphical controls of N applications, and when one of the N graphical controls is triggered, the electronic device starts an application corresponding to the graphical control; and the electronic device updates the home screen if a temperature of the electronic device is less than or equal to a first preset temperature, so that an updated home screen has less than N graphical controls, where N is a natural number greater than 1.

In this embodiment of this application, the home screen is displayed on a display screen of the electronic device, and the electronic device updates the home screen when the electronic device has a relatively low temperature, where the updated home screen has fewer graphical controls. In this manner, when the electronic device has a relatively low temperature, a user may be restricted from using some applications (for example, the user cannot use applications corresponding to graphical controls that disappear in the updated home screen). In this manner, power consumption of the electronic device is reduced as much as possible, to reduce a case in which the electronic device is powered off due to fast power reduction, thereby improving user experience.

In a possible design, the updated home screen has M graphical controls and N−M images, the N−M images are dimmed, the N−M images are images formed by N−M graphical controls reduced on the updated home screen, and M is a natural number greater than or equal to 1 and less than N; and the electronic device makes no response when one of the N−M images is triggered; or when the electronic device detects a first operation, the electronic device outputs prompt information if the first operation is performed within a location range of one of the N−M images, where the prompt information is used to remind the user that an application corresponding to the image is forbidden.

In this embodiment of this application, the home screen is displayed on the display screen of the electronic device, and the electronic device updates the home screen when the electronic device has a relatively low temperature, where the updated home screen has fewer graphical controls. The reduced graphical controls may be displayed in an image form. The electronic device makes no response or outputs prompt information when the user triggers an image. In this manner, when the electronic device has a relatively low temperature, the user may be restricted from using some applications (for example, the user cannot use applications corresponding to graphical control images dimmed on the updated home screen). In this manner, power consumption of the electronic device is reduced as much as possible, to reduce a case in which the electronic device is powered off due to fast power reduction, thereby improving user experience.

According to a third aspect, an embodiment of this application provides an application control method. The method is applicable to an electronic device. For example, the electronic device is a mobile phone or an iPad. The method includes: the electronic device detects a temperature of an internal key component; and the electronic device restricts the use of some functions of a currently running application if the temperature of the key component is less than a first preset temperature.

In this embodiment of this application, when the electronic device has a relatively low temperature, a user may be restricted from using some functions of an application. In this manner, power consumption of the electronic device is reduced as much as possible, to reduce a case in which the electronic device is powered off due to fast power reduction, thereby improving user experience.

In a possible design, before the electronic device restricts the use of some functions of the currently running application, the electronic device determines that a current load amount is greater than a preset load amount.

Usually, when the electronic device has a relatively low temperature, if the electronic device currently has a relatively high load amount; in other words, the electronic device has relatively high power consumption, the electronic device is tended to be powered off due to fast power reduction. To resolve this problem, in this embodiment of this application, when the electronic device has a relatively low temperature, the electronic device may restrict the use of some functions of the currently running application if the electronic device has a relatively high load amount. In this manner, power consumption of the electronic device is reduced as much as possible, to reduce a case in which the electronic device is powered off due to fast power reduction, thereby improving user experience.

In a possible design, the electronic device recovers these functions of the application when the temperature of the key component is greater than or equal to the first preset temperature or the current load amount is less than or equal to the preset load amount.

In this embodiment of this application, the electronic device may gradually recover a forbidden function in an application as the temperature of the electronic device gradually rises or the load amount gradually decreases. In this manner, the electronic device may flexibly restrict or enable some functions of an application based on a temperature change, so that power consumption of the electronic device is flexibly controlled based on the temperature change, to prevent as much as possible normal working of the electronic device from being affected due to an extremely low or extremely high temperature of the electronic device, thereby improving user experience.

In a possible design, that the electronic device restricts some functions of a currently running application includes: if the currently running application is making a video call, the electronic device switches the video call to a voice call; if the currently running application is playing a video, the electronic device switches a high definition mode currently used to play the video to a normal mode; or if the currently running application is playing audio, the electronic device switches a lossless audio quality mode currently used to play the audio to a normal mode.

In this embodiment of this application, when the electronic device has a relatively low temperature, if the electronic device is currently making a video call, the electronic device switches to a voice call; if the electronic device is currently playing a video, the electronic device switches a high definition mode currently used to play the video to a normal mode; or if the electronic device is currently playing audio, the electronic device switches a lossless audio quality mode currently used to play the audio to a normal mode. In this manner, power consumption of the electronic device is reduced as much as possible, to reduce a case in which the electronic device is powered off due to fast power reduction, thereby improving user experience.

In a possible design, when the application is Camera, that the electronic device restricts some functions of a currently running application includes: if Camera currently enables a portrait photographing mode, the electronic device switches the portrait photographing mode to a normal photographing mode; or the electronic device receives a first operation and starts Camera, and the electronic device outputs prompt information when detecting an operation that is output by the user to enable the portrait photographing mode in Camera, where the prompt information is used to remind the user that the portrait photographing mode is restricted.

In this embodiment of this application, if the electronic device displays a preview interface of the camera application, if the electronic device has a relatively low temperature, the electronic device exits the current portrait photographing mode and enters the normal photographing mode; or when the electronic device has a relatively low temperature, the electronic device outputs prompt information if the user enables the portrait photographing mode, to remind the user that the portrait photographing mode is restricted. In this manner, power consumption of the electronic device is reduced as much as possible, to reduce a case in which the electronic device is powered off due to fast power reduction, thereby improving user experience.

In a possible design, that the electronic device restricts some functions of a currently running application includes: if the electronic device detects that an application is currently performing a download task from a network device by using data traffic or Wi-Fi, the electronic device reduces a download speed, suspends the download task, disables the application, or disables the data traffic or Wi-Fi.

In this embodiment of this application, when the electronic device has a relatively low temperature, if the electronic device detects that an application is currently performing a download task from a network device by using data traffic or Wi-Fi, the electronic device may reduce a download speed, suspend the download task, disable the application, or disable the data traffic or Wi-Fi. In this manner, power consumption of the electronic device is reduced as much as possible, to reduce a case in which the electronic device is powered off due to fast power reduction, thereby improving user experience.

In a possible design, that the electronic device restricts some functions of a currently running application includes: if the electronic device detects that the electronic device is currently connected to another electronic device by using Bluetooth and is transmitting a file, the electronic device reduces a file transmission speed, suspends the file transmission, or interrupts the Bluetooth connection to the another electronic device.

In this embodiment of this application, when the electronic device has a relatively low temperature, if the electronic device is currently connected to another electronic device by using Bluetooth and is transmitting a file, the electronic device may reduce a file transmission speed, suspend the file transmission, or interrupt the Bluetooth connection to the another electronic device. In this manner, power consumption of the electronic device is reduced as much as possible, to reduce a case in which the electronic device is powered off due to fast power reduction, thereby improving user experience.

In a possible design, if a display screen of the electronic device is on, the electronic device reduces a display luminance value of the display screen; and/or if a speaker of the electronic device plays audio, the electronic device reduces a volume value of the audio play.

In this embodiment of this application, when the electronic device has a relatively low temperature, if the display screen of the electronic device is on, the display luminance value of the display screen may be reduced; and/or if the speaker of the electronic device plays audio, a volume value of the audio play may be reduced. In this manner, power consumption of the electronic device is reduced as much as possible, to reduce a case in which the electronic device is powered off due to fast power reduction, thereby improving user experience.

In a possible design, that the electronic device determines that a current load amount is greater than a preset load amount includes: the electronic device determines that a first current currently generated by a battery is greater than a preset current; or the electronic device determines that current CPU power consumption is greater than preset CPU power consumption.

In this embodiment of this application, the electronic device may detect whether the first current currently generated by the battery is greater than the preset current, to determine whether the current load amount is greater than the preset load amount; or the electronic device may detect whether the current CPU power consumption is greater than the preset CPU power consumption, to determine whether the current load amount is greater than the preset load amount.

According to a fourth aspect, an embodiment of this application provides an electronic device. The electronic device includes a display screen, a temperature sensor, and a processor. The display screen is configured to display a first user interface of a first application, where the first user interface has N graphical controls. The temperature sensor is configured to detect a temperature of the electronic device. The processor is configured to update the first user interface when the temperature of the electronic device is less than or equal to a first preset temperature. The display screen is further configured to display the updated first user interface, where the updated first user interface has less than N graphical controls, and N is a natural number greater than 1.

In a possible design, the updated first user interface has M graphical controls, and when one of the M graphical controls is triggered, the electronic device performs a function corresponding to the graphical control, where M is a natural number greater than or equal to 1 and less than N; and before the display screen displays the updated first user interface, the display screen is further configured to display a second user interface of the first application when the temperature of the electronic device is greater than the first preset temperature and less than or equal to a second preset temperature, where the second user interface has the N graphical controls, a luminance value of each of N−M graphical controls other than the M graphical controls in the N graphical controls is a first luminance value, the first luminance value is less than a second luminance value, and the second luminance value is a luminance value of each of the N−M graphical controls in the first user interface.

In a possible design, the updated first user interface has M graphical controls, and when one of the M graphical controls is triggered, the electronic device performs a function corresponding to the graphical control, where M is a natural number greater than or equal to 1 and less than N; and after the display screen displays the updated first user interface, the display screen is further configured to display a second user interface of the first application when the temperature of the electronic device is greater than the first preset temperature and less than or equal to a second preset temperature, where the second user interface has the N graphical controls, a first luminance value of N−M graphical controls other than the M graphical controls in the N graphical controls is less than a second luminance value, and the second luminance value is a luminance value of each of the N−M graphical controls in the first user interface; and the display screen is further configured to display the first user interface when the temperature of the electronic device is greater than the second preset temperature.

In a possible design, the display screen is further configured to display the updated first user interface instead of the first user interface when the temperature of the electronic device is greater than or equal to a third preset temperature, where the third preset temperature is greater than the second preset temperature.

In a possible design, when the temperature of the electronic device is greater than or equal to a third preset temperature, the display screen is further configured to no longer display the first user interface, and the processor is further configured to disable the first application, where the third preset temperature is greater than the second preset temperature; and the display screen is further configured to display a third user interface, where the third user interface is a display interface of a currently running second application.

In a possible design, when the first application is a camera application, the first user interface is a preview interface of the camera application, the preview interface has a graphical control of a portrait mode, and an updated preview interface does not have the graphical control of the portrait mode.

In a possible design, when the first application is a chat application, the first user interface is a chat interface of the chat application, the chat interface has a video call graphical control, a voice call graphical control, and a photographing graphical control, and an updated chat interface does not have one or more of the video call graphical control, the voice call graphical control, and the photographing graphical control.

In a possible design, the processor is further configured to display an icon or a text in a status bar by using the display screen in response to the updating of the first user interface, where the icon or the text is used to indicate that the temperature of the electronic device is less than or equal to the first preset temperature.

According to a fifth aspect, an embodiment of this application provides an electronic device. The electronic device includes a display screen, a temperature sensor, and a processor. The display screen is configured to display a home screen, where the home screen has N graphical controls of N applications. When one of the N graphical controls is triggered, the electronic device starts an application corresponding to the graphical control. The temperature sensor is configured to detect a temperature of the electronic device. The processor is configured to update the home screen when the temperature of the electronic device is less than or equal to a first preset temperature. The display screen is further configured to display an updated home screen, where the updated home screen has less than N graphical controls, and N is a natural number greater than 1.

In a possible design, the updated home screen has M graphical controls and N−M images, the N−M images are dimmed, the N−M images are images formed by N−M graphical controls reduced in the updated home screen, and M is a natural number greater than or equal to 1 and less than N; and the processor is further configured to: when detecting a trigger operation for one of the N−M images, make no response to the trigger operation; or when detecting a first operation, output prompt information if the first operation is performed within a location range of one of the N−M images, where the prompt information is used to remind a user that an application corresponding to the image is forbidden.

According to a sixth aspect, an embodiment of this application provides an electronic device, including a processor and a memory. The memory is configured to store one or more computer programs. When the one or more computer programs stored in the memory are executed by the processor, the electronic device is enabled to implement the method according to the first aspect or any possible design of the first aspect. Alternatively, when the one or more computer programs stored in the memory are executed by the processor, the electronic device is enabled to implement the method according to the second aspect or any possible design of the second aspect. Alternatively, when the one or more computer programs stored in the memory are executed by the processor, the electronic device is enabled to implement the method according to the third aspect or any possible design of the third aspect.

According to a seventh aspect, an embodiment of this application further provides an electronic device. The electronic device includes modules/units that perform the method according to the first aspect or any possible design of the first aspect. Alternatively, the electronic device includes modules/units that perform the method according to the second aspect or any possible design of the second aspect. Alternatively, the electronic device includes modules/units that perform the method according to the third aspect or any possible design of the third aspect. These modules/units may be implemented by hardware, or may be implemented by hardware by executing corresponding software.

According to an eighth aspect, an embodiment of this application further provides a computer readable storage medium. The computer readable storage medium includes a computer program. When the computer program runs on an electronic device, the electronic device is enabled to perform the method according to the first aspect or any possible design of the first aspect. Alternatively, when the computer program runs on an electronic device, the electronic device is enabled to perform the method according to the second aspect or any possible design of the second aspect. Alternatively, when the computer program runs on an electronic device, the electronic device is enabled to perform the method according to the third aspect or any possible design of the third aspect.

According to a ninth aspect, an embodiment of this application further provides a computer program product. When the computer program product runs on an electronic device, the electronic device is enabled to perform the method according to the first aspect or any possible design of the first aspect. Alternatively, when the computer program product runs on an electronic device, the electronic device is enabled to perform the method according to the second aspect or any possible design of the second aspect. Alternatively, when the computer program product runs on an electronic device, the electronic device is enabled to perform the method according to the third aspect or any possible design of the third aspect.

### BRIEF DESCRIPTION OF DRAWINGS

FIG. 1 is a schematic structural diagram of a mobile phone according to an embodiment of the present invention;

FIG. 2A(a) and FIG. 2A(b) are schematic diagrams of graphical user interfaces on a display screen of a mobile phone according to an embodiment of the present invention;

FIG. 2B(a) and FIG. 2B(b) are schematic diagrams of graphical user interfaces on a display screen of a mobile phone according to an embodiment of the present invention;

FIG. 2C(a) to FIG. 2C(c) are schematic diagrams of graphical user interfaces on a display screen of a mobile phone according to an embodiment of the present invention;

FIG. 2D(a) and FIG. 2D(b) are schematic diagrams of graphical user interfaces on a display screen of a mobile phone according to an embodiment of the present invention;

FIG. 2E(a) and FIG. 2E(b) are schematic diagrams of graphical user interfaces on a display screen of a mobile phone according to an embodiment of the present invention;

FIG. 3 is a schematic diagram of a graphical user interface on a display screen of a mobile phone according to an embodiment of the present invention;

FIG. 4 is a schematic diagram of a graphical user interface on a display screen of a mobile phone according to an embodiment of the present invention;

FIG. 5 is a schematic flowchart of an application control method according to an embodiment of the present invention;

FIG. 6 is a schematic flowchart of an application control method according to an embodiment of the present invention;

FIG. 7 is a schematic flowchart of an application control method according to an embodiment of the present invention; and

FIG. 8 is a schematic structural diagram of an electronic device according to an embodiment of the present invention.

### DESCRIPTION OF EMBODIMENTS

The following describes the technical solutions in the embodiments of this application with reference to the accompanying drawings in the embodiments of this application.

In the following, some terms in the embodiments of this application are described, so as to help a person skilled in the art have a better understanding.

“A plurality of” in the embodiments of this application means “two or greater than or equal to two”.

In addition, it should be understood that, terms such as “first” and “second” in the description of this application are described only for distinguishing purposes and should not be understood as an indication or implication of relative significance or as an indication or implication of an order.

The following describes an electronic device, a graphical user interface (graphical user interface, GUI) used in such an electronic device, and embodiments in which such an electronic device is used.

In some embodiments of this application, the electronic device may be a portable electronic device that further includes another function such as a personal digital assistant function and/or a music player function, for example, a mobile phone, a tablet computer, or a wearable device (for example, a smartwatch) having a wireless communication function. An example embodiment of the portable electronic device includes but is not limited to a portable electronic device using iOS, Android, Microsoft, or another operating system. Alternatively, the portable electronic device may be another portable electronic device, for example, a laptop (Laptop) having a touch-sensitive surface (for example, a touch panel). It should be further understood that, in some other embodiments of this application, the electronic device may not be a portable electronic device, but is a desktop computer having a touch-sensitive surface (for example, a touch panel).

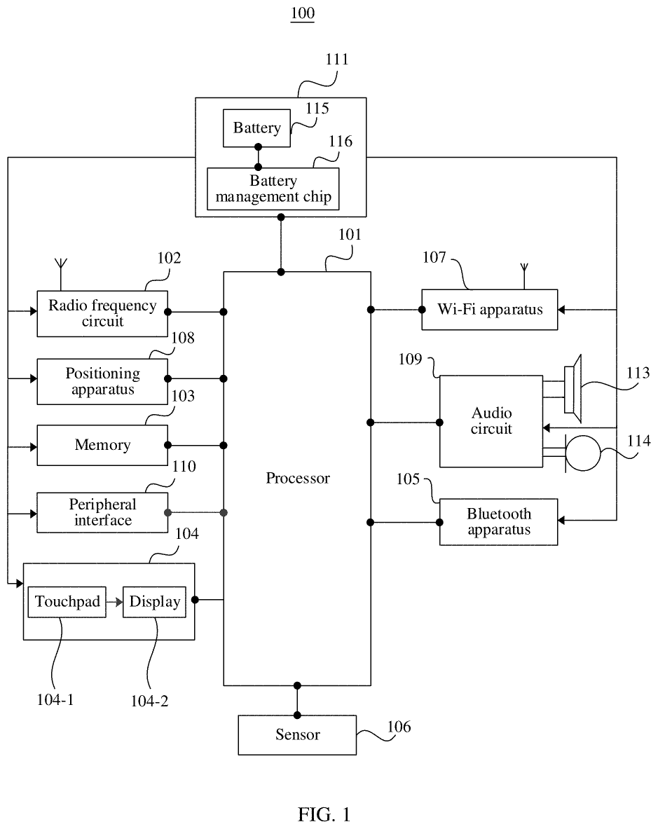

For example, the electronic device is a mobile phone. FIG. 1 is a structural diagram of a mobile phone according to an embodiment of this application. It should be understood that a mobile phone 100 shown in FIG. 1 is merely an example of the electronic device, and the mobile phone 100 may have more or fewer components than those shown in FIG. 1, may combine two or more components, or may have different component configurations. Various components shown in FIG. 1 may be implemented in hardware, software, or a combination of hardware and software including one or more signal processing and/or application-specific integrated circuits. The following describes the components in the mobile phone 100.

As shown in FIG. 1, the mobile phone 100 may include components such as one or more processors 101, a radio frequency (radio frequency, RF) circuit 102, a memory 103, a touchscreen 104, a Bluetooth apparatus 105, one or more sensors 106, a Wi-Fi apparatus 107, a positioning apparatus 108, an audio circuit 109, a peripheral interface 110, and a power apparatus 111. These components may perform communication by using one or more communications buses or signal cables (not shown in FIG. 1). A person skilled in the art may understand that a hardware structure shown in FIG. 1 constitutes no limitation on the mobile phone 100. The mobile phone 100 may include more or fewer components than those shown in FIG. 1, or combine some components, or have different component arrangements.

The following describes the components in the mobile phone 100 in detail with reference to FIG. 1.

The processor 101 is a control center of the mobile phone 100, connects all parts of the mobile phone 100 by using various interfaces and cables, and performs various functions of the mobile phone 100 and data processing by running or executing an application (Application, App for short) stored in the memory 103 and invoking data and an instruction that are stored in the memory 103. In some embodiments, the processor 101 may include one or more processing units. Alternatively, an application processor and a modem processor may be integrated into the processor 101. The application processor mainly processes an operating system, a user interface, an application, and the like. The modem processor mainly processes wireless communication. It may be understood that the modem processor may alternatively not be integrated into the processor 101. For example, the processor 101 may be a Kirin 960 chip manufactured by Huawei Technologies Co., Ltd. In some other embodiments of this application, the processor 101 may further include a fingerprint verification chip, configured to verify a collected fingerprint.

The radio frequency circuit 102 may be configured to receive and send a radio signal in an information receiving and sending process or in a call process. Specifically, after receiving downlink data from a base station, the radio frequency circuit 102 may send the downlink data to the processor 101 for processing. In addition, the radio frequency circuit 102 sends uplink data to the base station. Usually, the radio frequency circuit 102 includes but is not limited to an antenna, at least one amplifier, a transceiver, a coupler, a low noise amplifier, a duplexer, and the like. In addition, the radio frequency circuit 102 may further communicate with another device through wireless communication. The wireless communication may use any communications standard or protocol, including but not limited to a global system for mobile communications, a general packet radio service, code division multiple access, wideband code division multiple access, long term evolution, email, an SMS message service, and the like.

The memory 103 is configured to store an application and data. The processor 101 performs various functions of the mobile phone 100 and data processing by running the application and the data that are stored in the memory 103. The memory 103 mainly includes a program storage area and a data storage area. The program storage area may store an operating system, and an application required by at least one function (for example, an audio play function or an image play function). The data storage area may store data (for example, audio data or an address book) created based on the use of the mobile phone 100. In addition, the memory 103 may include a high-speed random access memory, or may include a nonvolatile memory such as a magnetic disk storage device, a flash storage device, or another nonvolatile solid-state storage device. The memory 103 may store various operating systems such as an iOS operating system developed by Apple Inc. and an Android operating system developed by Google Inc. For example, the memory 103 stores an application related to the embodiments of this application, such as Taskcard store, Twitter, Contacts, or Weibo.

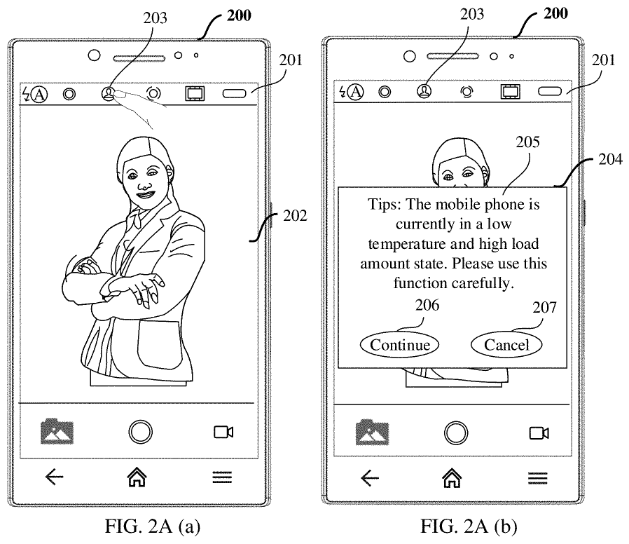

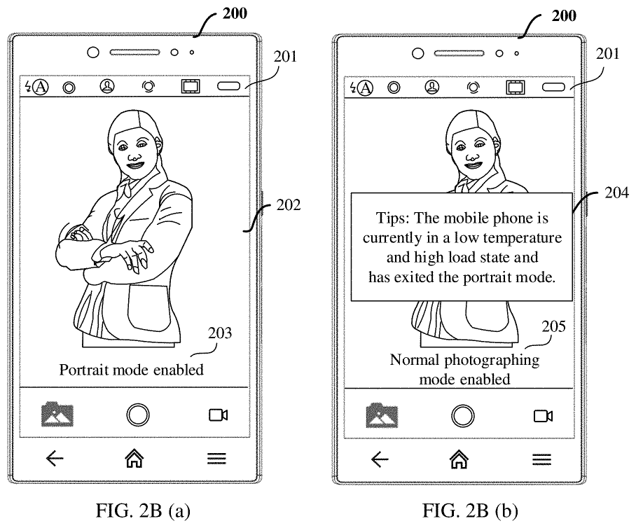

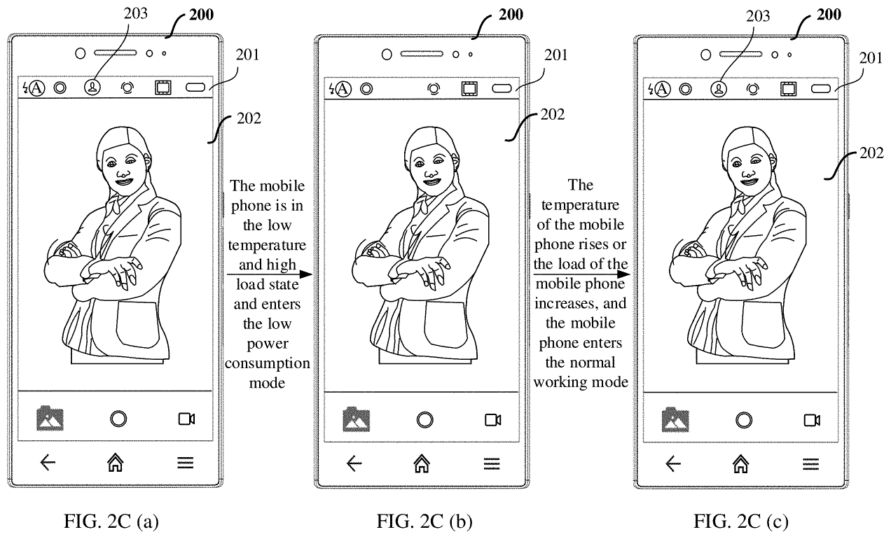

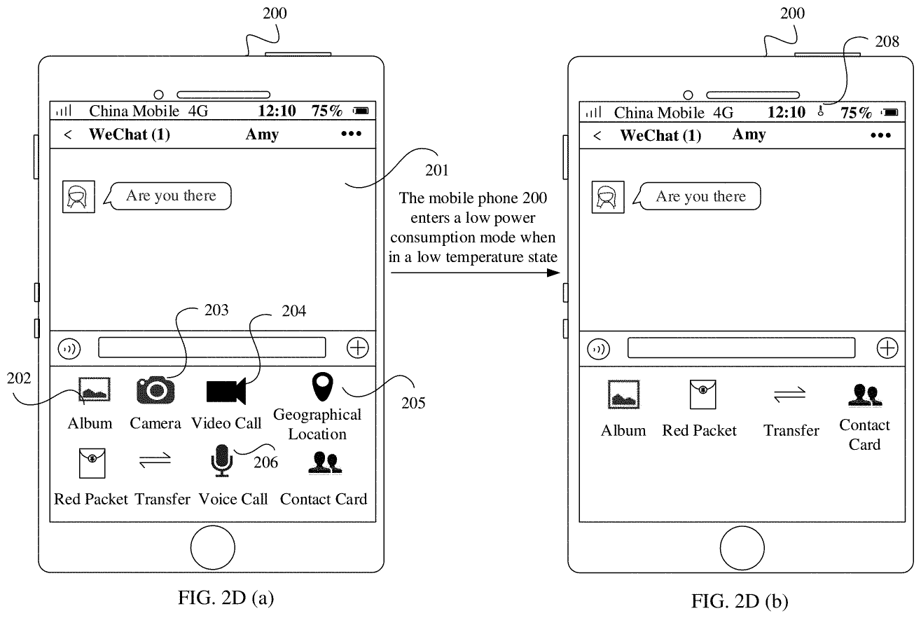

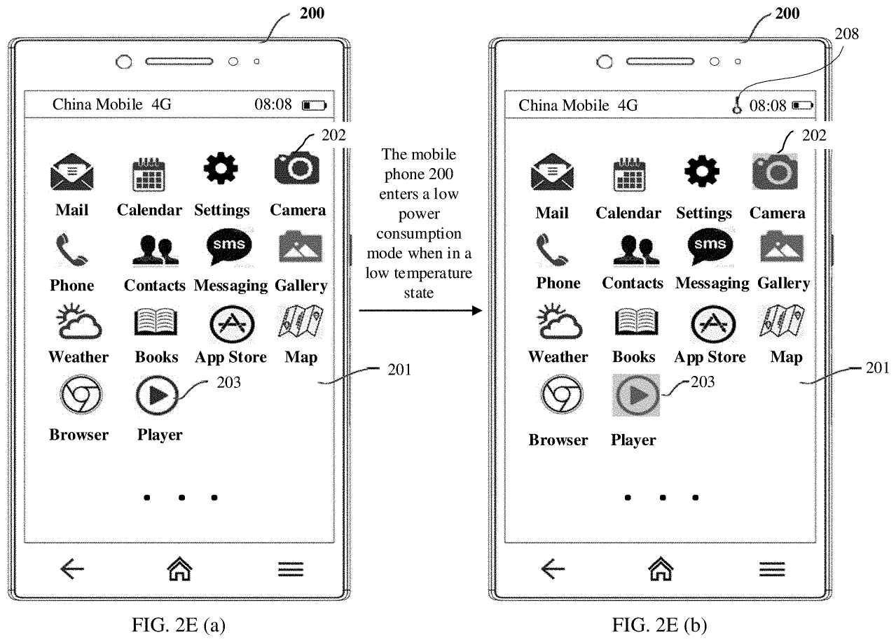

The touchscreen 104 may include a touch-sensitive surface 104-1 and a display 104-2. The touch-sensitive surface 104-1 (for example, a touch panel) may collect a touch event performed by a user of the mobile phone 100 on or near the touch-sensitive surface 104-1 (for example, an operation performed by the user on the touch-sensitive surface 104-1 or near the touch-sensitive surface 104-1 by using any proper object such as a finger or a stylus), and send collected touch information to another component, for example, the processor 101. A touch event performed by the user near the touch-sensitive surface 104-1 may be referred to as a floating touch. The floating touch may mean that the user does not need to directly contact a touchpad for selecting, moving, or dragging an object (for example, an APP icon), and the user only needs to be near the electronic device to perform a desired function. In an application scenario of the floating touch, terms such as “touch” and “contact” do not imply a direct contact with the touchscreen 104, but a contact near or close to the touchscreen 104. The touch-sensitive surface 104-1 on which the floating touch can be performed may be implemented by using a capacitive type, an infrared light sensor, an ultrasonic wave, and the like. The touch-sensitive surface 104-1 may include two parts: a touch detection apparatus and a touch controller. The touch detection apparatus detects a touch direction of the user, detects a signal brought by a touch operation, and transfers the signal to the touch controller. The touch controller receives touch information from the touch detection apparatus, and converts the touch information into coordinates of a touch point and then sends the coordinates of the touch point to the processor 101. The touch controller may further receive and execute an instruction sent by the processor 101. In addition, the touch-sensitive surface 104-1 may be implemented by using a plurality of types such as a resistive type, a capacitive type, an infrared ray, and a surface acoustic wave. The display (also referred to as a display screen) 104-2 may be configured to display information entered by the user or information provided for the user, and various menus of the mobile phone 100. The display 104-2 may be configured in a form of a liquid crystal display, an organic light emitting diode, or the like. The touch-sensitive surface 104-1 may cover the display 104-2. When detecting a touch event on or near the touch-sensitive surface 104-1, the touch-sensitive surface 104-1 transfers the touch event to the processor 101 to determine a type of the touch event. Then, the processor 101 may provide a corresponding visual output on the display 104-2 based on the type of the touch event. In FIG. 2A(a) to FIG. 2E(b), the touch-sensitive surface 104-1 and the display screen 104-2 are used as two independent parts to implement input and output functions of the mobile phone 100. However, in some embodiments, the touch-sensitive surface 104-1 and the display screen 104-2 may be integrated to implement the input and output functions of the mobile phone 100. It may be understood that the touchscreen 104 is formed by stacking a plurality of layers of materials. In this embodiment of this application, only the touch-sensitive surface (layer) and the display screen (layer) are displayed, and other layers are not described in this embodiment of this application. In addition, in some other embodiments of this application, the touch-sensitive surface 104-1 may cover the display 104-2, and a size of the touch-sensitive surface 104-1 is greater than a size of the display screen 104-2, so that the display screen 104-2 is entirely covered by the touch-sensitive surface 104-1. Alternatively, the touch-sensitive surface 104-1 may be configured on the front of the mobile phone 100 in a full panel form; in other words, any touch performed by the user on the front of the mobile phone 100 can be sensed by the mobile phone. In this way, full touch control experience on the front of the mobile phone can be implemented. In some other embodiments, the touch-sensitive surface 104-1 is configured on the front of the mobile phone 100 in the full panel form, and the display screen 104-2 may also be configured on the front of the mobile phone 100 in the full panel form. In this way, a bezel-less structure can be implemented on the front of the mobile phone. In some other embodiments of this application, the touchscreen 104 may further include a series of pressure sensor arrays, so that the mobile phone senses pressure applied by a touch event to the touchscreen 104.

The mobile phone 100 may further include the Bluetooth apparatus 105, configured to implement data exchange between the mobile phone 100 and another electronic device (for example, a mobile phone or a smartwatch) at a short distance from the mobile phone 100. The Bluetooth apparatus in this embodiment of this application may be an integrated circuit, a Bluetooth chip, or the like.

The mobile phone 100 may further include at least one sensor 106, such as a light sensor, a motion sensor, and other sensors. Specifically, the light sensor may include an ambient light sensor and a proximity sensor. The ambient light sensor may adjust luminance of the display of the touchscreen 104 based on brightness of ambient light. The proximity sensor may power off the display when the mobile phone 100 moves to an ear. As a type of motion sensor, an accelerometer sensor may detect values of accelerations in all directions (usually on three axes), may detect a value and a direction of gravity when the mobile phone is stationary, and may be applied to an application for recognizing a mobile phone posture (for example, screen switching between landscape and portrait modes, a related game, and magnetometer posture calibration), a function related to vibration recognition (such as a pedometer and a knock), and the like.

In some embodiments of this application, the sensor 106 may further include a fingerprint sensor. For example, the fingerprint sensor may be configured on the back of the mobile phone 100 (for example, a lower part of a rear-facing camera), or the fingerprint sensor may be configured on the front of the mobile phone 100 (for example, a lower part of the touchscreen 104). In addition, the fingerprint sensor may be configured in the touchscreen 104 to implement a fingerprint recognition function. In other words, the fingerprint sensor may be integrated with the touchscreen 104 to implement the fingerprint recognition function of the mobile phone 100. In this case, the fingerprint sensor may be configured in the touchscreen 104 and may be a part of the touchscreen 104, or may be configured in the touchscreen 104 in another manner. In addition, the fingerprint sensor may be implemented as a full panel fingerprint sensor. Therefore, the touchscreen 104 may be considered as a panel on which a fingerprint can be collected at any location. The fingerprint sensor may send a collected fingerprint to the processor 101, so that the processor 101 processes the fingerprint (for example, verifies the fingerprint). The fingerprint sensor in some embodiments of this application may use any type of sensing technology, including but not limited to an optical sensing technology, a capacitive sensing technology, a piezoelectric sensing technology, an ultrasonic wave sensing technology, or the like. In addition, for a specific technical solution of integrating a fingerprint sensor in a touchscreen in this embodiment of this application, refer to patent application No. US 2015/0036065 A1, entitled “FINGERPRINT SENSOR IN ELECTRONIC DEVICE”, announced by the United States Patent and Trademark Office, where all controls are incorporated in the embodiments of this application by reference.

In some embodiments of this application, the sensor 106 may further include a temperature sensor. For example, the temperature sensor may be connected to each component (for example, the processor 130) (or the temperature sensor is configured at a location close to each component), and is configured to detect a surface temperature of each component. After detecting a surface temperature of each component in the mobile phone 100, the temperature sensor sends the surface temperature of each component to the processor 101. In other words, the processor 130 may monitor a component with a relatively high or relatively low surface temperature.

Other sensors such as a gyroscope, a barometer, a hygrometer, and an infrared sensor that may be further configured in the mobile phone 100 are not described herein.

The mobile phone 100 may further include the Wi-Fi apparatus 107, configured to provide, for the mobile phone 100, network access that complies with a Wi-Fi-related standard protocol. The mobile phone 100 may access a Wi-Fi access point by using the Wi-Fi apparatus 107, to help the user receive and send an email, browse a web page, access streaming media, and the like. The Wi-Fi apparatus 107 provides a wireless broadband Internet access for the user. In some other embodiments, the Wi-Fi apparatus 107 may also be used as a Wi-Fi wireless access point, and may provide Wi-Fi network access for another electronic device.

The mobile phone 100 may further include the positioning apparatus 108, configured to provide a geographical location for the mobile phone 100. It may be understood that the positioning apparatus 108 may be specifically a receiver of a positioning system such as a global positioning system (global positioning system, GPS) or a BeiDou navigation satellite system. After receiving a geographical location sent by the positioning system, the positioning apparatus 108 sends the information to the processor 101 for processing, or sends the information to the memory 103 for storage. In some other embodiments, the positioning apparatus 108 may be a receiver of an assisted global positioning system (assisted global positioning system, AGPS). The AGPS is a running manner of performing GPS positioning with mobile assistance. The AGPS may enable positioning of the mobile phone 100 to be faster by using a signal of a base station in combination with a GPS satellite signal. In the AGPS system, the positioning apparatus 108 may obtain positioning assistance by communicating with an assisted positioning server (for example, a positioning server of the mobile phone 100). The AGPS system is used as an assisted server to assist the positioning apparatus 108 in completing ranging and positioning services. In this case, the assisted positioning server provides positioning assistance by communicating with the positioning apparatus 108 (namely, a receiver of the GPS) of the electronic device such as the mobile phone 100 by using a wireless communications network. In some other embodiments, the positioning apparatus 108 may alternatively be a positioning technology based on a Wi-Fi access point. Each Wi-Fi access point has a globally unique MAC address, and the electronic device can scan and collect a broadcast signal of a surrounding Wi-Fi access point when Wi-Fi is enabled. Therefore, the electronic device can obtain a MAC address broadcast by the Wi-Fi access point. The electronic device sends such data (for example, the MAC address) that can identify the Wi-Fi access point to a location server by using a wireless communications network. The location server retrieves a geographical location of each Wi-Fi access point, calculates a geographical location of the electronic device with reference to strength of the Wi-Fi broadcast signal, and sends the geographical location of the electronic device to the positioning apparatus 108 of the electronic device.

The mobile phone 100 may further include the audio circuit 109, a speaker 113, and a microphone 114, configured to provide an audio interface between the user and the mobile phone 100. The audio circuit 109 may transmit, to the speaker 113, an electrical signal converted from received audio data, and the loudspeaker 113 converts the electrical signal into a sound signal for output. In addition, the microphone 114 converts a collected sound signal into an electrical signal, and the audio circuit 109 receives the electrical signal and then converts the electrical signal into audio data, and outputs the audio data to the radio frequency circuit 102 to send the audio data to, for example, a mobile phone, or outputs the audio data to the memory 103 for further processing.

The mobile phone 100 may further include the peripheral interface 110, configured to provide various interfaces for an external input/output device (for example, a keyboard, a mouse, an external display, an external memory, or a subscriber identity module card). For example, the peripheral interface 110 is connected to the mouse by using a universal serial bus interface, and is connected, by using a metal touch point on a subscriber identity module card slot, to the subscriber identity module (subscriber identity module, SIM) card provided by a telecommunications operator. The peripheral interface 110 may be configured to couple the external input/output peripheral device to the processor 101 and the memory 103.

The mobile phone 100 may further include the power apparatus 111 that supplies power to each component. The battery apparatus 111 may include a battery 115 and a power management chip 116. The mobile phone 100 may further implement functions such as charge management, discharge management, and power consumption management by using the power apparatus 111. For example, the battery 115 may be logically connected to the processor 101 or another component by using the power management chip 116, and the power management chip 116 may control the battery 115 to supply or not to supply power to each component.

Although not shown in FIG. 1, the mobile phone 100 may further include a camera, for example, a front-facing camera or a rear-facing camera. The front-facing camera may be configured to capture face feature information, and the processor 101 may perform facial recognition on the face feature information, and then perform subsequent processing. The mobile phone 100 may further include a camera flash, a micro projection apparatus, a near field communication (near field communication, NFC) apparatus, and the like. Details are not described herein.

All the following embodiments may be implemented in an electronic device (for example, the mobile phone 100 or a tablet computer) of the foregoing hardware structure.

Usually, performance of each component in the mobile phone 100 is affected by an ambient temperature. For example, a temperature of the battery 115 decreases when the mobile phone 100 is at a relatively low ambient temperature. Lithium ion activeness of the battery 115 decreases when the temperature of the battery 115 decreases, resulting in an increase in a positive electrolyte resistance value and a negative electrolyte resistance value of the lithium battery, and further, an increase in an internal resistance of the battery 115. It may be learned from Ohm's law U=Ir+IR (where U is an electromotive force, I is a current generated by a battery, R is a resistance of a component, and r is an internal resistance of the battery) that the generated current I decreases after the internal resistance r of the battery 115 increases. Because the current generated by the battery 115 decreases, the mobile phone 100 is more likely to be powered off due to fast power reduction if each component consumes a larger current when working.

Therefore, in some embodiments of this application, to avoid fast power reduction due to relatively high power consumption at a low temperature as much as possible, when the mobile phone 100 has a relatively low temperature, the mobile phone 100 may control each component in the mobile phone 100 by using a low power consumption mode (the low power consumption mode is described in the following).

It may be learned from the foregoing content that the temperature sensor in the mobile phone 100 may detect the temperature of each component, and send the detected temperature of the component to the processor 130. The processor 130 compares the received temperature of the component with a preset temperature, and the mobile phone 100 is in a low temperature state if the temperature of the component is less than the preset temperature (for example, the preset temperature is −10 degrees Celsius). Alternatively, the processor 130 determines whether the received temperature of the component falls within a preset temperature range (for example, the preset temperature range is −10 degrees Celsius to 10 degrees Celsius), and the mobile phone 100 is in a low temperature state if yes.

Optionally, the sensor in the mobile phone 100 may detect only a temperature of a key component. To be specific, when the temperature of the key component is less than the preset temperature or falls within the preset temperature range, it indicates that the mobile phone 100 is in a low temperature state. The key component herein may be the processor 130, the battery 115, or the like, and is not limited in this embodiment of this application.

In some other embodiments of this application, when the mobile phone 100 is in the low temperature state, the mobile phone 100 may further control each component by using a corresponding policy based on a current load amount. For example, when the temperature of the mobile phone 100 is less than the preset temperature (in other words, the mobile phone 100 is in the low temperature state), and the mobile phone 100 currently has a relatively high load amount, the low power consumption mode may be used to reduce power consumption as much as possible, to avoid power-off caused by fast power reduction due to high power consumption. For another example, when the mobile phone 100 currently has a relatively low load amount, a high power consumption mode may be used to increase the temperature of the component in the mobile phone 100, to prevent the component in the mobile phone 100 from being damaged due to an extremely low temperature. In this manner, regardless of whether the mobile phone 100 currently has a high or low load amount, it is ensured as much as possible that the mobile phone 100 is normally used.

The mobile phone 100 may detect the current load amount when the mobile phone 100 is currently in the low temperature state. Then, the mobile phone 100 uses different policies based on the current load amount. The following describes several possible implementations in which the mobile phone 100 detects the current load amount.

In a possible implementation, the mobile phone 100 may detect, by using the battery management chip 116, the current generated by the battery 115. It may be learned from the foregoing content that the battery management chip 116 may control the battery 115 to supply or not to supply power to each component. When a plurality of components in the mobile phone 100 are in a working state, the battery 115 needs to supply power to the plurality of components. Therefore, when the battery management chip 116 detects that the battery 115 generates a relatively large current, it indicates that a relatively large quantity of components in the mobile phone 100 are currently in the working state; in other words, the mobile phone 100 currently has a relatively high load.

In another possible implementation, the mobile phone 100 may detect a quantity of currently running applications. When a relatively large quantity of applications are running, the mobile phone 100 determines that the current load amount is relatively high. When a relatively small quantity of applications are running, the mobile phone 100 determines that the current load amount is relatively low.

In still another possible implementation, the mobile phone 100 may detect overall power consumption. If the overall power consumption is relatively high, it indicates that the mobile phone 100 currently has a relatively high load amount. If the overall power consumption is relatively low, it indicates that the mobile phone 100 currently has a relatively low load amount.

The mobile phone 100 may detect power consumption of each component to obtain the overall power consumption. For example, the mobile phone 100 may determine a working current of each component (for example, the battery management chip 116 in the mobile phone 100 may detect a current provided by the battery 115 for each component) and working time of each component. A working current of a component is multiplied by working time of the component to obtain power consumption of the component. After obtaining the power consumption of each component, the mobile phone 100 adds power consumption of all the components to obtain the overall power consumption.

Certainly, the mobile phone 100 may alternatively detect only power consumption of some key components, such as CPU power consumption and memory power consumption. The CPU power consumption is used as an example. When the CPU power consumption is relatively high, it indicates that the mobile phone 100 currently has a relatively high load amount. When the CPU power consumption is relatively low, it indicates that the mobile phone 100 currently has a relatively low load amount. The CPU power consumption is still used as an example. The mobile phone 100 may store a CPU power consumption threshold. The mobile phone 100 is in a high load amount state if the CPU power consumption is greater than the CPU power consumption threshold. The mobile phone 100 is in a low load amount state if the CPU power consumption is less than or equal to the CPU power consumption threshold. Certainly, the mobile phone 100 may alternatively store a CPU power consumption range. The mobile phone 100 is in a high load amount state if the CPU power consumption is greater than a maximum value in the CPU power consumption range. The mobile phone 100 is in a low load amount state if the CPU power consumption is less than a minimum value in the CPU power consumption range.

The foregoing enumerates the several manners in which the mobile phone 100 detects the current load amount. In actual application, the mobile phone 100 may alternatively detect the current load amount in another manner. This is not limited in this embodiment of this application. It can be learned from the foregoing content that when the mobile phone 100 is in the low temperature state, the low power consumption mode may be used if the current load amount is relatively high; or the high power consumption mode may be used if the current load amount is relatively low. The following separately describes the two cases.

In a first case, when the mobile phone 100 is in the low temperature state, and the load amount is greater than a preset load amount (for example, the load amount is the CPU power consumption, and the preset load amount may be the CPU power consumption threshold) (for ease of description, hereinafter referred to as a low temperature and high load state), the mobile phone 100 is controlled to enter the low power consumption mode.

For example, the mobile phone 100 may automatically enter the low power consumption mode when detecting that the mobile phone 100 is currently in the low temperature and high load state. After the mobile phone 100 detects that the current load amount decreases, the mobile phone 100 automatically exits the low power consumption mode and recovers a normal working mode.

For another example, a control (for example, the control may be displayed on the display screen of the mobile phone 100 in an icon form or a text form) may be disposed in the mobile phone 100, and the mobile phone 100 enters the low power consumption mode after the control is triggered by the user. When the control is triggered again, the mobile phone 100 exits the low power consumption mode and recovers a normal working mode.

In some embodiments of this application, overall power consumption (or CPU power consumption) of the mobile phone 100 in the low power consumption mode is lower than current overall power consumption (or CPU power consumption) of the mobile phone 100. For example, when the mobile phone 100 is in the low power consumption mode, values of working parameters (for example, a working current, display luminance of the display screen, and a volume of audio output by the speaker) of some components in the mobile phone 100 are reduced, some currently running applications are disabled, or some functions of a currently running application are restricted. To enable which component to have a relatively small working parameter value in the low power consumption mode, to disable which application in the low power consumption mode, or to restrict which functions of which application in the low power consumption mode may be set at delivery of the mobile phone 100, or may be set by the user in a process of using the mobile phone 100.

In a possible implementation, the mobile phone 100 may reduce parameter values of some output devices after the mobile phone 100 enables the low power consumption mode when detecting that the mobile phone 100 is currently in the low temperature and high load state. For example, the mobile phone 100 may reduce a display luminance value of the display 104-2. For another example, the mobile phone 100 may reduce a volume value of output audio of the speaker 113 if the mobile phone 100 detects that the mobile phone 100 is currently using the speaker 113 (for example, the user uses the mobile phone 100 to make a voice or video call, play music, or play a video).

In some embodiments of this application, the mobile phone 100 may further output prompt information to the user before reducing the display luminance value of the display 104-2 or the volume value of the output audio of the speaker 113. The prompt information is used to prompt the user to reduce display luminance of the display screen or the volume value of the output audio of the speaker. The prompt information may be displayed by using the display 104-2, or may be output by using the speaker 113 or the like. After outputting the prompt information, the mobile phone 100 may automatically reduce the display luminance of the display 104-2 or the volume value of the output audio of the speaker 113. Alternatively, after outputting the prompt information, the mobile phone 100 may reduce the display luminance of the display 104-2 or the volume value of the output audio of the speaker 113 based on an operation of the user. For example, the user manually reduces the display luminance of the display 104-2 or the volume value of the output audio of the speaker 113. Alternatively, the mobile phone 100 further displays two selection controls (a cancel control and an OK control) when displaying the prompt information. The mobile phone 100 still maintains the normal working mode when the user selects the cancel control. The mobile phone 100 may automatically reduce the display luminance of the display 104-2 or the volume value of the output audio of the speaker 113 when the user selects the OK control. Certainly, the mobile phone 100 may alternatively automatically reduce the display luminance of the display 104-2 or the volume value of the output audio of the speaker 113 without outputting the prompt information.

When reducing the display luminance value of the display 104-2 or the volume value of the output audio of the speaker 113, the mobile phone 100 may reduce the display luminance of the display 104-2 to a first preset luminance value or reduce the volume value of the output audio of the speaker 113 to a first preset volume value. The first preset luminance value or the first preset volume value is not limited in this embodiment of this application.

For example, when the mobile phone 100 is currently making a video call (for example, a video call in WeChat or QQ), the mobile phone 100 may automatically switch the video call to a voice call if the mobile phone 100 detects that the mobile phone 100 is currently in the low temperature and high load amount state. For another example, when the mobile phone 100 is currently playing music, the mobile phone 100 may switch a currently used lossless audio quality mode to a standard audio quality mode if the mobile phone 100 detects that the mobile phone 100 is currently in the low temperature and high load state. For another example, when the mobile phone 100 is currently playing a video online, the mobile phone 100 may reduce video playing resolution, for example, switch a high definition play mode to a normal play mode, if the mobile phone 100 detects that the mobile phone 100 is currently in the low temperature and high load state.

For another example, when the mobile phone 100 is currently in the low temperature and high load state, if the user starts WeChat or QQ to enable a video call, the mobile phone 100 may output prompt information, where the prompt information is used to remind the user that the mobile phone 100 is currently in the low temperature and high load state and a voice call is recommended (or the mobile phone 100 disables the video call, for example, if the user triggers a video call control, the mobile phone 100 makes no response or outputs prompt information to remind the user that the video call is disabled). Alternatively, when the mobile phone 100 is currently in the low temperature and high load state, if the user starts a music player to play music, the mobile phone 100 uses a standard audio quality mode by default, and if the user triggers a lossless audio quality mode, the mobile phone 100 may output prompt information, where the prompt information is used to remind the user that the mobile phone 100 is currently in the low temperature and high load amount state and the standard audio quality mode is recommended (or the mobile phone 100 disables a lossless audio quality mode, for example, if the user triggers a lossless audio quality mode control, the mobile phone 100 makes no response or outputs prompt information to remind the user that the lossless audio quality mode is disabled). Alternatively, when the mobile phone 100 is currently in the low temperature and high load state, if the user starts a video player to play a video, the mobile phone 100 uses a common play mode by default, and if the user triggers a high definition play mode, the mobile phone 100 may output prompt information, where the prompt information is used to remind the user that the mobile phone 100 is currently in the low temperature and high load state and the common play mode is recommended (or the mobile phone 100 disables a high definition play mode, for example, if the user triggers a high definition play mode control, the mobile phone 100 makes no response or outputs prompt information to remind the user that the high definition play mode is disabled).

In another possible implementation, the mobile phone 100 may restrict some functions of a currently running application after the mobile phone 100 enables the low power consumption mode when detecting that the mobile phone 100 is currently in the low temperature and high load state. Different functions are restricted for different applications. The following uses several applications as examples for description.

In a first example, when the mobile phone 100 is in the low temperature and high load state, if the mobile phone 100 detects that the mobile phone 100 is currently running Camera, the mobile phone 100 enables a normal photographing mode by default, and disables other photographing modes. Usually, Camera has a relatively large quantity of photographing modes, such as the normal photographing mode, a portrait mode, and a beauty mode. The portrait mode is used as an example. When Camera enables the portrait mode, a face recognition module in the mobile phone 100 is enabled to identify a face in a preview image, resulting in a relatively large calculation amount and relatively high power consumption. Compared with other photographing modes, the common photographing mode has the lowest power consumption. For example, in the normal photographing mode, Camera of the mobile phone 100 enables fewer parameters (such as an aperture and an exposure), and each parameter has a relatively small value.

In some embodiments of this application, the mobile phone 100 may output prompt information when detecting an operation that the user starts Camera, where the prompt information is used to remind the user that the mobile phone 100 is currently in the low temperature and high load state and some functions of Camera are restricted. Alternatively, the mobile phone 100 may automatically restrict the use of some functions when detecting an operation that the user starts Camera. For example, when the user triggers the functions, there is no response for the functions, or icons corresponding to the functions become dimmed, or prompt information pops up to remind the user that the mobile phone 100 is currently in the low temperature and high load state and the functions are restricted.

The portrait mode is still used as an example. If Camera has been started and entered the portrait mode, when the mobile phone 100 detects that the mobile phone 100 is currently in the low temperature and high load state, the mobile phone 100 may exit the portrait mode and enable the normal photographing mode. Certainly, the mobile phone 100 may further output prompt information after exiting the portrait mode, where the prompt information is used to remind the user that the mobile phone 100 is currently in the low temperature and high load state and the portrait mode has been exited.

For example, FIG. 2A(a), FIG. 2A(b), FIG. 2B(a) and FIG. 2B(b) are schematic diagrams of graphical user interfaces on a display screen of a mobile phone according to an embodiment of this application.

In FIG. 2A(a), a mobile phone 200 displays a preview interface 201 of Camera, and the preview interface 201 includes a preview image 202 and a portrait photographing mode icon 203. In FIG. 2A(b), when a user taps the portrait photographing mode icon 203 with a finger, a prompt box 204 pops up on the mobile phone 200. Prompt information 205, a continue control 206, and a cancel control 207 are displayed in the prompt box 204. The prompt information 205 displays “Tips: The mobile phone is currently in a low temperature and high load amount state. Please use this function carefully”. The mobile phone 200 hides the prompt box 204 when the user triggers the cancel control 207. The mobile phone 200 enables a portrait photographing mode when the user triggers the continue control 206.

In FIG. 2B(a), a mobile phone 200 displays a preview interface 201 of Camera, and the preview interface 201 includes a preview image 202 and text information 203 (the text information 203 displays “Portrait mode enabled”). In FIG. 2B(b), the mobile phone 200 displays prompt information 204. The prompt information 204 displays “The mobile phone is currently in a low temperature and high load amount state and has exited the portrait mode”. In addition, the text information 203 in the preview interface 201 disappears, and text information 205 “Normal photographing mode enabled” is displayed.

Only the portrait photographing mode in Camera is used as an example for description in FIG. 2A(a), FIG. 2A(b), FIG. 2B(a) and FIG. 2B(b). In an actual operation process, the mobile phone 100 may collect statistics on a function of each control in Camera and power consumption of each function, and set a function with relatively high power consumption as a function restricted at a low temperature.

In some other embodiments of this application, if the mobile phone 100 currently displays a preview interface of Camera, the mobile phone 100 automatically enters the low power consumption mode when the mobile phone 100 detects that the mobile phone 100 is currently in the low temperature and high load state. After the mobile phone 100 enters the low power consumption mode, some graphical controls in the preview image that is of Camera and that is displayed on the mobile phone 100 gradually disappear, or the graphical controls are gradually dimmed (there is no response when the dimmed graphical controls are triggered by the user).

For example, FIG. 2C(a) to FIG. 2C(c) are schematic diagrams of graphical user interfaces on a display screen of a mobile phone according to an embodiment of this application.

In FIG. 2C(a), a mobile phone 200 displays a preview interface 201 of Camera, and the preview interface 201 includes a preview image 202 and a portrait photographing mode icon 203. In this case, the mobile phone 200 enters a low power consumption mode if the mobile phone 200 is in a low temperature and high load state. In FIG. 2C(b), the portrait photographing mode icon 203 in the preview interface 201 disappears. Certainly, the mobile phone 200 may directly hide the portrait photographing mode icon 203 when entering low power consumption. Alternatively, when entering the low power consumption mode, the mobile phone 200 may control a corresponding control to gradually disappear, or control the corresponding control to be dimmed When a temperature of the mobile phone 200 gradually rises, the graphical control disappeared from the preview interface 201 gradually recovers, as shown in FIG. 2C(c).

For example, the mobile phone 200 may store a temperature range, for example, −10 degrees Celsius to 10 degrees Celsius. When a current temperature of the mobile phone 200 is less than 10 degrees Celsius, a current first luminance value of the portrait photographing mode icon 203 in the preview interface 201 starts to decrease. When the temperature of the mobile phone 200 is greater than −10 degrees Celsius and less than 0 degrees Celsius, the luminance value of the portrait photographing mode icon 203 in the preview interface 201 decreases to a second luminance value (the second luminance value is less than the first luminance value). When the temperature of the mobile phone 200 is less than −10 degrees Celsius, the portrait photographing mode icon 203 in the preview interface 203 completely disappears. Certainly, the temperature range from —10 degrees Celsius to 10 degrees Celsius is merely an example, and constitutes no limitation on this embodiment of this application.

For example, FIG. 2D(a) and FIG. 2D(b) are schematic diagrams of graphical user interfaces on a display screen of a mobile phone according to an embodiment of this application.

In FIG. 2D(a), a mobile phone 200 displays a chat interface 201 of WeChat, and the chat interface 201 of WeChat includes an album icon 202, a camera control 203, a video call icon 204, a geographical location icon 205, and a voice call icon 206. In this case, the mobile phone 200 enters a low power consumption mode if the mobile phone 200 is currently in a low temperature state. In FIG. 2D(b), the album icon 202, the camera control 203, the video call icon 204, the geographical location icon 205, and the voice call icon 206 in the chat interface 201 of WeChat gradually disappear (or the album icon 202, the camera control 203, the video call icon 204, the geographical location icon 205, and the voice call icon 206 may be dimmed), and an icon 208 is displayed in a status bar of the mobile phone 200. The icon 208 indicates that the mobile phone 200 is currently in the low temperature state. When a temperature of the mobile phone 200 gradually rises, the graphical controls disappeared from the chat interface 201 of WeChat gradually recover; in other words, recover to those in FIG. 2D(a), and the icon 208 in the status bar disappears.

For example, the mobile phone 200 displays a display interface of an app, and the mobile phone 200 enters the low power consumption mode when the mobile phone 200 detects that the mobile phone 200 is currently in a low temperature and high load state. The mobile phone 200 may disable the app and display a display interface of another currently running app. For example, the mobile phone 200 currently displays a preview interface of Camera. When the mobile phone 100 detects that the mobile phone 100 is currently in the low temperature and high load state, the mobile phone 200 enters the low power consumption mode, and the mobile phone 100 disables Camera and displays an interface of WeChat running in the background.

In still another possible implementation, the mobile phone 100 may restrict the use of some applications after the mobile phone 100 enables the low power consumption mode when detecting that the mobile phone 100 is currently in the low temperature and high load state. For example, icons of some applications on the display screen of the mobile phone 100 are dimmed When the user triggers a dimmed icon, there is no response or prompt information (the prompt information is used to remind the user that the application cannot be used because the mobile phone 100 is currently in the low temperature and high load state) is output. In some embodiments of this application, the mobile phone 100 may store a list. The list stores an identifier of an application (for example, a name of the application) that needs to be dimmed in the low power consumption mode. Specifically, an application in the list may be set at delivery of the mobile phone 100. Alternatively, the mobile phone 100 may intelligently identify power consumption of each application in a use process. If power consumption of an application is greater than a threshold, the mobile phone 100 automatically adds an identifier of the application to the list. Alternatively, the user may manually update the list. For example, in a process of using the mobile phone 100, the user may add an identifier of an application to the list based on a selection of user.

For example, FIG. 2E(a) and FIG. 2E(b) are schematic diagrams of graphical user interfaces on a display screen of a mobile phone according to an embodiment of this application.

In FIG. 2E(a), a mobile phone 200 displays a home screen 201, and the home screen 201 has graphical controls of applications, including a Camera graphical control 202 and a Player graphical control 203. In this case, the mobile phone 200 enters a low power consumption mode if the mobile phone 200 is currently in a low temperature state. In FIG. 2E(b), the Camera graphical control 202 and the Player graphical control 203 on the home screen 201 are displayed in an image form, and are dimmed (simultaneously, a low power consumption mode icon 208 is displayed in a status bar of the mobile phone 200). In FIG. 2E(b), the Camera graphical control 202 and the Player graphical control 203 are images, and are not controls anymore. Therefore, the mobile phone 200 makes no response when a user triggers an image of the player graphical control 203. Alternatively, when the mobile phone 200 detects an operation triggered by a user, the mobile phone 200 outputs prompt information if the operation is performed within a location range of an image of the Player graphical control 203. The prompt information is used to remind the user that Player is forbidden.

When a temperature of the mobile phone 200 gradually rises, the Camera graphical control 202 and the Player graphical control 203 gradually recover on the home screen 201; in other words, recover to those in FIG. 2E(a), and the low power consumption mode icon 208 in the status bar disappears.

In a second example, when the mobile phone 100 detects that the mobile phone 100 is currently in the low temperature and high load state, if the mobile phone 100 detects that a download task is currently performed in the background, the mobile phone 100 may restrict a download speed or suspend the download task. For example, when the mobile phone 100 detects that the download task is currently performed by using data traffic or Wi-Fi, the mobile phone 100 may reduce the download speed or suspend the download task, to reduce power consumption.

Usually, there are a plurality of scenarios in which the mobile phone 100 has a download task in the background. For example, a download task exists in a Xunlei application in the mobile phone 100, or an audio or video file is being downloaded or cached in an audio or video play application in the mobile phone 100, for example, a video is being downloaded in an iQIYI application. Therefore, the mobile phone 100 may determine currently running applications, and then detect whether a download task is being performed in each application. If the mobile phone 100 detects that a download task is currently performed in an application, the mobile phone 100 may restrict a download speed or suspend the download task.

In some embodiments of this application, the mobile phone 100 may further output prompt information when detecting that a download task is currently performed in the background. The prompt information is used to remind the user that the mobile phone 100 is currently in the low temperature and high load amount state and a download speed of the download task is restricted or the download task is suspended. Certainly, the user may alternatively choose to still perform the download task at the original download speed.

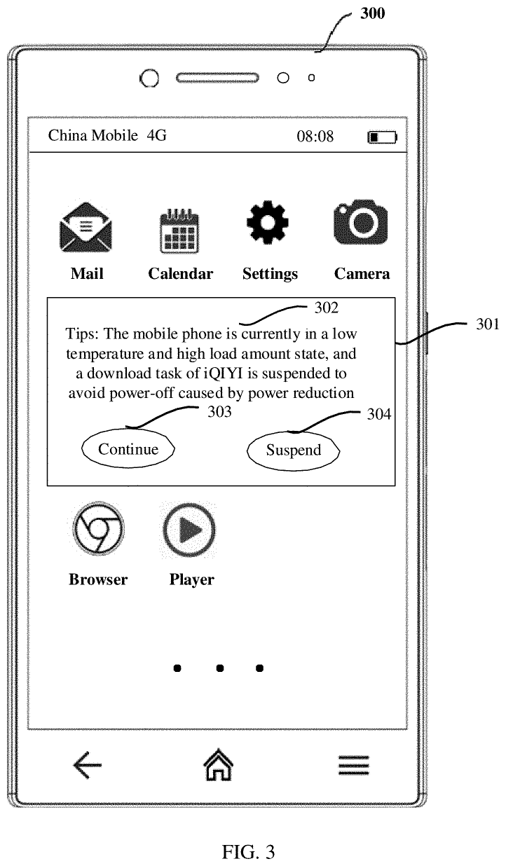

For example, FIG. 3 is a schematic diagram of a graphical user interface on a display screen of a mobile phone according to an embodiment of this application.

In FIG. 3, the mobile phone is used as an example. A prompt box 301 is displayed on a display screen of a mobile phone 300. Prompt information 302 is displayed in the prompt box 301, and the prompt information 302 displays “The mobile phone is currently in a low temperature and high load amount state, and a download task of iQIYI is suspended”. The mobile phone continues a cache task if the user chooses to trigger a continue control 303. The mobile phone 300 suspends the downloading if the user chooses to trigger a suspend control 304.

In a third example, when the mobile phone 100 detects that the mobile phone 100 is currently in a low temperature and high load state, if the mobile phone 100 detects that the mobile phone 100 is currently connected to and communicates with another device (for example, the mobile phone 100 is connected to another device by using Bluetooth and transmits a file), the mobile phone 100 may restrict a file transmission speed, suspend the file transmission, or interrupt the connection to the another device.

In some embodiments of this application, the mobile phone 100 may output prompt information before restricting the file transmission speed, suspending the file transmission, or interrupting the connection to the another device. The prompt information is used to remind the user that the mobile phone 100 is currently in the low temperature and high load amount state, and the mobile phone 100 is to restrict the file transmission speed, suspend the file transmission, or interrupt the connection to the another device.

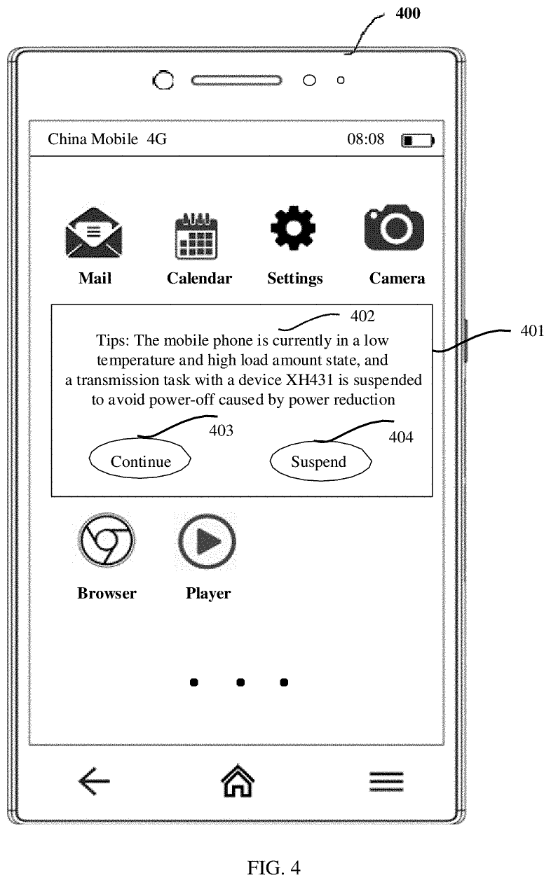

For example, FIG. 4 is a schematic diagram of a graphical user interface on a display screen of a mobile phone according to an embodiment of this application.

In FIG. 4, the mobile phone is used as an example. A prompt box 401 is displayed on a display screen of a mobile phone 400. Prompt information 402 is displayed in the prompt box 401, and the prompt information 402 displays “The mobile phone is currently in a low temperature and high load amount state, and a file transmission task with a device XH431 is suspended”. The mobile phone 400 continues file transmission with the device XH431 if the user chooses to trigger a continue control 403. The mobile phone 400 suspends the transmission if the user chooses to trigger a suspend control 404.

The mobile phone 100 enters the low power consumption mode if the mobile phone 100 is in the low temperature and high load state. The mobile phone 100 may enter the normal working mode after power consumption gradually decreases. For example, after the mobile phone 100 enters the low power consumption mode, the battery management chip 116 in the mobile phone 100 may detect, in real time, a current generated by the battery 115, and the mobile phone 100 recovers from the low power consumption mode to the normal working mode when the current generated by the battery 115 decreases to a preset current. In the normal working mode, the mobile phone 100 may recover, to an original value, a working parameter value that is of a component in a working state and that is reduced in the low power consumption mode, re-start a disabled application, or may recover a restricted function in an application.

In a second case, when the mobile phone 100 is in the low temperature state, and the load amount is less than or equal to a preset load amount (for example, the load amount is the CPU power consumption, and the preset load amount may be the CPU power consumption threshold) (for ease of description, hereinafter referred to as a low temperature and low load state), the mobile phone 100 is controlled to enter the high power consumption mode.

For example, the mobile phone 100 may automatically enter the high power consumption mode when detecting that the mobile phone 100 is currently in the low temperature and low load state. After the mobile phone 100 detects that the current load amount increases, the mobile phone 100 automatically exits the high power consumption mode and recovers a normal working mode.

In a possible implementation, the mobile phone 100 may increase values of parameters of some output devices when the mobile phone 100 is in the low temperature and low load state.

For example, the mobile phone 100 may increase a display luminance value of the display 104-2. For another example, the mobile phone 100 may increase a volume value of output audio of the speaker 113 if the mobile phone 100 is currently using the speaker 113 (for example, the user uses the mobile phone 100 to make a voice or video call, play music, or play a video).

Optionally, the mobile phone 100 may further output prompt information before increasing the display luminance value of the display 104-2 or the volume value of the output audio of the speaker 113. The prompt information is used to prompt the user to increase display luminance of the display screen or the volume value of the output audio of the speaker. The prompt information may be displayed by using the display 104-2, or may be output by using the speaker 113 or the like. Certainly, the mobile phone 100 may automatically increase the display luminance of the display 104-2 or the volume value of the output audio of the speaker 113 after outputting the prompt information. When increasing the display luminance value of the display 104-2 or the volume value of the output audio of the speaker 113, the mobile phone 100 may increase the display luminance of the display 104-2 to a second preset luminance value or increase the volume value of the output audio of the speaker to a second preset volume value. The second preset luminance value or the second preset volume value is not limited in this embodiment of this application.

In another possible implementation, when the mobile phone 100 is in the low temperature and low load state, the mobile phone 100 may increase a working current, power, or the like of a component currently in a working state.

For example, the mobile phone 100 may increase a charge current when the mobile phone 100 is in a charge state. The mobile phone 100 may increase a working current or power of a component when the mobile phone 100 is in a working state. For example, the mobile phone 100 may increase power of the RF circuit when detecting that the mobile phone 100 is currently using the RF circuit. The mobile phone 100 uses the RF circuit in a relatively large quantity of scenarios, such as a scenario in which the mobile phone 100 is in a voice or video call or the mobile phone 100 downloads a resource from a network side. In actual application, the mobile phone 100 may further increase a working current or power of another component in a working state. This is not limited in this embodiment of this application.

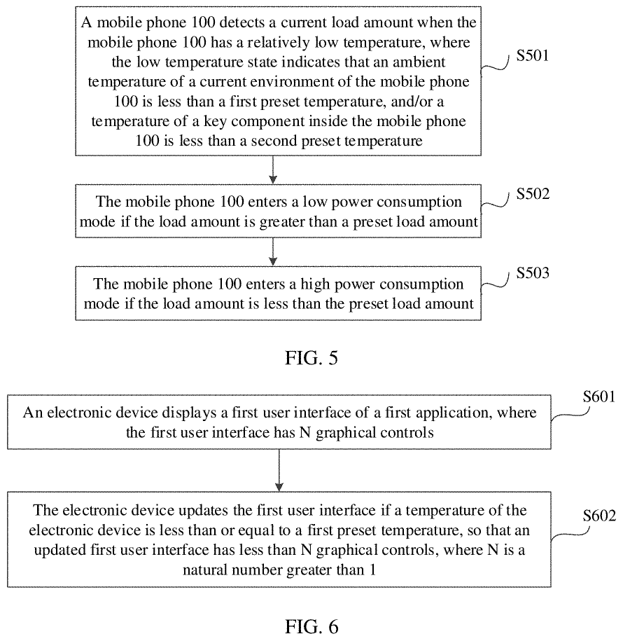

FIG. 5 is a schematic flowchart of an application control method according to an embodiment of this application. The method is applicable to the mobile phone 100 shown in FIG. 1. Therefore, the following uses the mobile phone 100 as an example. As shown in FIG. 5, a process of the method includes the following steps.

S501. The mobile phone 100 detects a current load amount when the mobile phone 100 is in a low temperature state, where the low temperature state indicates that an ambient temperature of a current environment of the mobile phone 100 is less than a first preset temperature, and/or a temperature of a key component inside the mobile phone 100 is less than a second preset temperature.

In some embodiments of this application, the mobile phone 100 may obtain, from a network-side device, a weather forecast of a current geographical location of the mobile phone 100, or may detect the ambient temperature of the current environment of the mobile phone 100 by using a temperature sensor disposed on a surface of the mobile phone 100. The mobile phone 100 may detect the temperature of the key component by using a built-in temperature sensor. For example, the mobile phone 100 may detect a surface temperature of the key component by using the temperature sensor. The key component herein may be agreed upon in advance, for example, include a battery, a CPU, or a memory. Alternatively, the key component may be a component invoked by an application currently displayed on the mobile phone 100. For example, the key component may include a camera if the mobile phone 100 currently displays a preview interface of Camera.

S501 may include three cases. In a first case, only the ambient temperature is considered. To be specific, the current load amount is detected when the ambient temperature of the current environment of the mobile phone 100 is less than the first preset temperature. In a second case, only the temperature of the key component inside the mobile phone 100 is considered. To be specific, the current load amount is detected when the temperature of the key component in the mobile phone 100 is less than the second preset temperature. In a third case, both the ambient temperature and the temperature of the key component in the mobile phone 100 are considered. To be specific, the current load amount is detected when the ambient temperature of the current environment of the mobile phone 100 is less than the first preset temperature, and the surface temperature of the key component inside the mobile phone 100 is less than the second preset temperature. In this embodiment of this application, the first preset temperature may be the same as or different from the second preset temperature, and specific values of the first preset temperature and the second preset temperature are not limited in this embodiment of this application.

It may be learned from the foregoing content that the mobile phone 100 may determine the current load amount by detecting the overall power consumption, the CPU power consumption, or the like. For brevity of the specification, details are not described herein again.

S502. The mobile phone 100 enters a low power consumption mode if the load amount is greater than a preset load amount.

In this embodiment of this application, when the mobile phone 100 is in a low temperature and high load state, the mobile phone 100 may enable the low power consumption mode, to reduce power consumption of the mobile phone 100, thereby reducing a possibility that the mobile phone 100 is automatically powered off due to fast power reduction.

Certainly, before the mobile phone 100 enters the low power consumption mode, in addition to considering whether the current load amount of the mobile phone 100 is greater than the preset load amount, the mobile phone 100 may further consider whether a current remaining electricity quantity of the mobile phone 100 is less than an electricity quantity threshold. To be specific, S602 specifically includes: the mobile phone 100 enters the low power consumption mode if the load amount is greater than the preset load amount and the current remaining electricity quantity is less than the electricity quantity threshold. When the mobile phone 100 is in a low temperature and low load state, if the mobile phone 100 currently has a relatively large electricity quantity, the mobile phone 100 may not enable the low power consumption mode; in other words, continue to use a normal working mode.

S503. The mobile phone 100 enters a high power consumption mode if the load amount is less than the preset load amount.

Usually, when the mobile phone 100 is in the low temperature state, if the load amount is relatively low, a temperature of the mobile phone 100 is relatively difficult to rise, and a low temperature damages each component in the mobile phone 100. Therefore, the mobile phone 100 may enter the high power consumption mode, to prevent as much as possible each component in the mobile phone 100 from being damaged due to a low temperature.

Certainly, before the mobile phone 100 enters the high power consumption mode, in addition to considering whether the current load amount of the mobile phone 100 is less than the preset load amount, the mobile phone 100 may further consider whether the current remaining electricity quantity of the mobile phone 100 is greater than or equal to the electricity quantity threshold. To be specific, S603 specifically includes: the mobile phone 100 enters the high power consumption mode if the load amount is less than the preset load amount and the current remaining electricity quantity is greater than or equal to the electricity quantity threshold. When the mobile phone 100 is in the low temperature and low load state, if the mobile phone 100 currently has a relatively small electricity quantity, the mobile phone 100 may not enable the high power consumption mode; in other words, continue to use the normal working mode.

In the embodiments shown in FIG. 2A(a) to FIG. 5, when the mobile phone 100 is in the low temperature state, the mobile phone 100 is controlled, based on the current load amount, to enter the low power consumption mode or the high power consumption mode. In actual application, the same idea may also be used when the mobile phone 100 is in a high temperature state. For example, when the mobile phone 100 is in the high temperature state, if the mobile phone 100 currently has a relatively large load amount, to prevent the mobile phone 100 from emitting heat, the mobile phone 100 may enter the low power consumption mode.

FIG. 6 is a schematic flowchart of an application control method according to an embodiment of this application. The method is applicable to the mobile phone 100 shown in FIG. 1. Therefore, the following uses the mobile phone 100 as an example. As shown in FIG. 6, a process of the method includes the following steps.

S601. An electronic device displays a first user interface of a first application, where the first user interface has N graphical controls.

The electronic device may be the mobile phone 100 shown in FIG. 1, or may be another device. For example, the electronic device is the mobile phone 100 shown in FIG. 1. A plurality of applications may be installed in the mobile phone 100. When the mobile phone 100 displays a first user interface of an application, the first user interface includes N graphical controls, and each graphical control corresponds to one function. For example, when a user triggers a graphical control, the electronic device performs a function corresponding to the graphical control.

For example, when the first application is a camera application, for a first user interface of the camera application, refer to, for example, the preview interface 201 in FIG. 2C(a). When the first application is a WeChat application, for a first user interface of the WeChat application, refer to, for example, the preview interface 201 in FIG. 2D(a).

S602. The electronic device updates the first user interface if a temperature of the electronic device is less than or equal to a first preset temperature, so that an updated first user interface has less than N graphical controls, where N is a natural number greater than 1.

For example, the electronic device is still the mobile phone 100 shown in FIG. 1. In the foregoing content, the mobile phone 200 may store the temperature range, for example, −10 degrees Celsius to 10 degrees Celsius. When a current temperature of the mobile phone 200 is less than −10 degrees Celsius, the mobile phone 100 updates a first user interface, and an updated first user interface has fewer graphical controls.

For example, when the first application is a camera application, refer to FIG. 2C(a) to FIG. 2C(c). The first user interface is shown in FIG. 2C(a), and the first user interface includes the portrait photographing mode icon 203. When the temperature of the mobile phone 200 is less than −10 degrees Celsius, the mobile phone 200 updates the first user interface, as shown in FIG. 2C(b). To be specific, the updated first user interface does not have the portrait photographing mode icon 203. After the temperature of the mobile phone 200 rises, the mobile phone 200 recovers display of the first user interface, as shown in FIG. 2C(c).

Certainly, the portrait photographing mode icon 203 may gradually disappear in a process from FIG. 2C(a) to FIG. 2C(b). For example, when the current temperature of the mobile phone 200 is less than 10 degrees Celsius, a current first luminance value of the portrait photographing mode icon 203 in the preview interface 201 starts to decrease. When the temperature of the mobile phone 200 is greater than −10 degrees Celsius and less than 0 degrees Celsius, the luminance value of the portrait photographing mode icon 203 in the preview interface 201 decreases to a second luminance value (the second luminance value is less than the first luminance value). When the temperature of the mobile phone 200 is less than −10 degrees Celsius, the portrait photographing mode icon 203 in the preview interface 203 completely disappears, as shown in FIG. 2C(b).

Similarly, the portrait photographing mode icon 203 may gradually recover in a process from FIG. 2C(b) to FIG. 2C(c). For example, when the temperature of the mobile phone 200 is less than −10 degrees Celsius, the portrait photographing mode icon 203 in the preview interface 203 completely disappears, as shown in FIG. 2C(b). When the temperature of the mobile phone 200 rises to fall within a range greater than −10 degrees Celsius and less than 0 degrees Celsius, the portrait photographing mode icon 203 appears in the preview interface 201. In this case, the portrait photographing mode icon 203 has relatively low luminance. When the temperature of the mobile phone 200 continues to rise to be greater than 10 degrees Celsius, the mobile phone 200 completely recovers the first user interface (to be specific, luminance of the portrait photographing mode icon 203 is increased to the same luminance as that in (a)).

For another example, when the first application is a WeChat application, refer to FIG. 2D(a) and FIG. 2D(b). The mobile phone 200 enters a low power consumption mode if the mobile phone 200 is currently in a low temperature state. As shown in FIG. 2D(b), the album icon 202, the camera control 203, the video call icon 204, the geographical location icon 205, and the voice call icon 206 in the chat interface 201 of WeChat gradually disappear. FIG. 2D(b). These graphical controls may also gradually disappear in a process from FIG. 2D(a) to FIG. 2D(b), and the foregoing has described the process in which the graphical controls gradually disappear. For brevity of the specification, details are not described herein again.

FIG. 2C(a) to FIG. 2C(c) are still used as examples. If the temperature of the mobile phone 200 continuously rises, for example, rises to 20 degrees Celsius, the mobile phone 200 displays the updated first user interface instead of the first user interface. To be specific, when the mobile phone 200 has a relatively high temperature, the mobile phone 200 displays the interface shown in FIG. 2C(b). In other words, when the mobile phone 200 has a relatively high temperature, the mobile phone 200 may alternatively control some graphical controls in an application to disappear; in other words, restrict some functions, to reduce the temperature of the mobile phone as much as possible.

For another example, when the temperature of the mobile phone 200 continuously rises, for example, rises to 20 degrees Celsius, the mobile phone 200 does not display the first user interface, and disables the first application. The mobile phone displays a third display interface of a currently running second application. FIG. 2C(a) to FIG. 2C(c) are still used as examples. When the mobile phone 200 has a relatively high temperature, the mobile phone 200 disables the camera application, and displays a user interface of another currently running application.

In some embodiments of this application, after updating the first user interface of the first application, the mobile phone 200 displays an icon or text information in a status bar. The icon or text information is used to indicate that the mobile phone 200 currently has a relatively low temperature. Referring to FIG. 2C (b), the icon 208 is displayed in the status bar of the mobile phone 200.

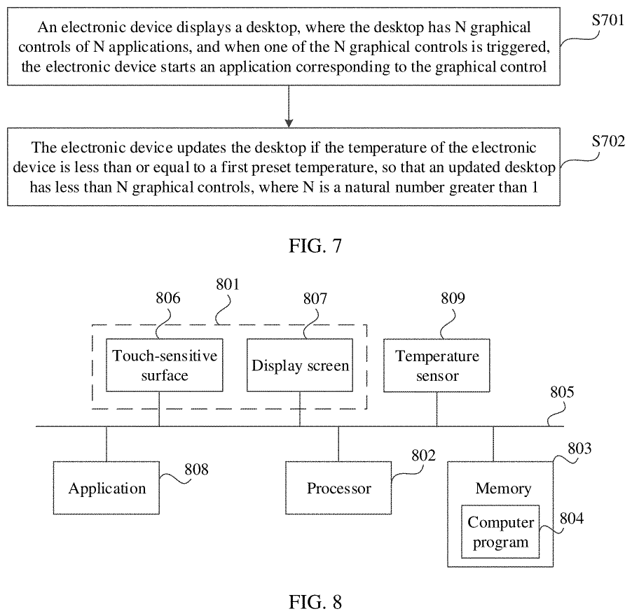

FIG. 7 is a schematic flowchart of an application control method according to an embodiment of this application. The method is applicable to an electronic device. For example, the electronic device is the mobile phone 100 shown in FIG. 1. Therefore, the following uses the mobile phone 100 as an example. As shown in FIG. 7, a process of the method includes the following steps.

S701. The electronic device displays a home screen, where the home screen has N graphical controls of N applications, and when one of the N graphical controls is triggered, the electronic device starts an application corresponding to the graphical control.

S702. The electronic device updates the home screen if the temperature of the electronic device is less than or equal to a first preset temperature, so that an updated home screen has less than N graphical controls, where N is a natural number greater than 1.

FIG. 2E(a) and FIG. 2E(b) are used as examples. As shown in FIG. 2E(a), the mobile phone 200 displays the home screen, and displays graphical controls of applications on the home screen. As shown in FIG. 2E(b), the mobile phone 200 updates the home screen when the mobile phone 200 is in a low temperature state, and an updated home screen has fewer graphical controls. For example, the Player graphical control 203 and the Camera graphical control 202 are displayed in an image form and are dimmed, and are not graphical controls anymore (to be specific, there is no response when the user triggers the Player graphical control 203 and the Camera graphical control 202).

The implementations of this application may be combined at random to implement different technical effects.

In the embodiments provided in this application, the methods provided in the embodiments of this application are described from a perspective of using an electronic device as an execution body. To implement functions in the foregoing methods provided in the embodiments of this application, the electronic device may include a hardware structure and/or a software module, and implement the functions in a form of a hardware structure, a software module, or a hardware structure and a software module. Whether one of the functions is performed in a form of a hardware structure, a software module, or a hardware structure and a software module depends on particular applications and design constraint conditions of the technical solutions.

As shown in FIG. 8, some other embodiments of this application disclose an electronic device. The electronic device is, for example, a mobile phone or an iPad. The electronic device may include: a touchscreen 801, where the touchscreen 801 includes a touch-sensitive surface 806 and a display screen 807; one or more processors 802; a plurality of applications 808; and a temperature sensor 809, where the foregoing components may be connected by using one or more communications buses 805. The temperature sensor 809 may be configured to detect a temperature of the electronic device, and the display screen 807 may be configured to display a display interface of one of the plurality of applications 808. Alternatively, the display screen 807 may be further configured to display a home screen of the electronic device, or the like.

One or more computer programs 804 are stored in a memory 803 and are used to be executed by the one or more processors 802. The one or more computer programs 804 include an instruction, and the instruction may be used to perform the steps in FIG. 5 to FIG. 7 and the corresponding embodiments.

It should be noted that, in the embodiments of this application, unit division is an example, and is merely logical function division. In actual implementation, another division manner may be used. Functional units in the embodiments of the present invention may be integrated into one processing unit, or each of the units may exist alone physically, or two or more units are integrated into one unit. For example, in the foregoing embodiments, the first obtaining unit and the second obtaining unit may be a same unit or different units. The foregoing integrated unit may be implemented in a form of hardware, or may be implemented in a form of a software functional unit.

According to the context, the term “when” used in the foregoing embodiments may be interpreted as a meaning of “if”, “after”, “in response to determining”, or “in response to detecting”. Similarly, according to the context, the phrase “when it is determined that” or “if (a stated condition or event) is detected” may be interpreted as a meaning of “if it is determined that”, “in response to determining”, “when (a stated condition or event) is detected”, or “in response to detecting (a stated condition or event)”.

All or some of the foregoing embodiments may be implemented by using software, hardware, firmware, or any combination thereof. When software is used to implement the embodiments, the embodiments may be implemented completely or partially in a form of a computer program product. The computer program product includes one or more computer instructions. When the computer program instructions are loaded and executed on a computer, the procedure or functions according to the embodiments of this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive), or the like.

For a purpose of explanation, the foregoing description is described with reference to a specific embodiment. However, the foregoing example discussion is not intended to be detailed, and is not intended to limit this application to a disclosed precise form. According to the foregoing teaching content, many modification forms and variation forms are possible. Embodiments are selected and described to fully illustrate the principles of this application and practical application of the principles, so that other persons skilled in the art can make full use of this application and various embodiments that have various modifications applicable to conceived specific usage.

In the embodiments provided in this application, the method provided in the embodiments of this application is described from a perspective in which a terminal device is used as an execution body. To implement functions in the method provided in the embodiments of this application, the terminal device may include a hardware structure and/or a software module, and implement the functions in a form of the hardware structure, the software module, or a combination of the hardware structure and the software module. Whether a function of the foregoing functions is performed by using the hardware structure, the software module, or the combination of the hardware structure and the software module depends on specific applications and design constraint conditions of the technical solutions.

1-23. (canceled)

24. An electronic device, comprising:
a touchscreen;
one or more processors coupled to the touchscreen; and
a memory coupled to the one or more processors and storing instructions which, when executed by the one or more processors, cause the first electronic device to be configured to:
display a home screen on the touchscreen, wherein the home screen comprises an icon of a first application;
detect a first touch operation on the icon of the first application;
display a first user interface of the first application in response to the first touch operation, wherein the first user interface comprises N graphical controls, a luminance value of each of N−M graphical controls other than the M graphical controls in the N graphical controls is a first luminance value, the first luminance value is less than a second luminance value, and the second luminance value is a luminance value of each of the N−M graphical controls in the first user interface, wherein M, N are natural numbers, and M is greater than or equal to 1 and less than N;
update the first user interface when detecting a temperature of the electronic device is less than or equal to a first preset temperature, wherein an updated first user interface comprises M graphical controls which has less than N graphical controls;
display a second user interface of the first application when the temperature of the electronic device is greater than the first preset temperature and less than or equal to a second preset temperature, wherein the second user interface has the N graphical controls, a first luminance value of N−M graphical controls other than the M graphical controls in the N graphical controls is less than a second luminance value, and the second luminance value is a luminance value of each of the N−M graphical controls in the first user interface;
display the first user interface when the temperature of the electronic device is greater than the second preset temperature;
display the updated first user interface instead of the first user interface when the temperature of the electronic device is greater than or equal to a third preset temperature, wherein the third preset temperature is greater than the second preset temperature.

25. The electronic device of claim 24, wherein the electronic device is further caused to: display a second user interface of the first application when the temperature of the electronic device is greater than a first preset temperature and less than or equal to a second preset temperature.

26. The electronic device of claim 24, wherein the electronic device is further caused to: skip displaying the first user interface and disabling the first application when the temperature of the electronic device is greater than or equal to a third preset temperature, wherein the third preset temperature is greater than the second preset temperature; and
display a third user interface, wherein the third user interface is a display interface of a currently running second application.

27. The electronic device of claim 24, wherein the electronic device is further caused to: skip displaying the first user interface and disabling the first application when the temperature of the electronic device is greater than or equal to a third preset temperature, wherein the third preset temperature is greater than the second preset temperature; and
display a third user interface, wherein the third user interface is a display interface of a currently running second application.

28. The electronic device of claim 24, wherein the first application is a camera application, the first user interface is a preview interface of the camera application, the preview interface has a graphical control of a portrait mode, and an updated preview interface does not have the graphical control of the portrait mode.

29. The electronic device of claim 24, wherein the first application is a chat application, the first user interface is a chat interface of the chat application, the chat interface has a video call graphical control, a voice call graphical control, and a photographing graphical control, and an updated chat interface does not have one or more of the video call graphical control, the voice call graphical control, and the photographing graphical control.

30. The electronic device of claim 24, wherein the electronic device is further caused to: display an icon or a text in a status bar in response to the updating of the first user interface, wherein the icon or the text is used to indicate that the temperature of the electronic device is less than or equal to the first preset temperature.

31. An electronic device, comprising:
a touchscreen;
one or more processors coupled to the touchscreen; and
a memory coupled to the one or more processors and storing instructions which, when executed by the one or more processors, cause the first electronic device to be configured to:
display a home screen on the touchscreen, wherein the home screen has N graphical controls of N applications, and when one of the N graphical controls is triggered, the electronic device starts an application corresponding to the graphical control;
update the home screen when detecting a temperature of the electronic device is less than or equal to a first preset temperature, wherein an updated home screen has less than N graphical controls, wherein N is a natural number greater than 1, the updated home screen has M graphical controls and N−M images, the N−M images are dimmed, the N−M images are images formed by N−M graphical controls reduced on the updated home screen, and M is a natural number greater than or equal to 1 and less than N;
detect a first operation;
display prompt information when the first operation is performed within a location range of one of the N−M images, wherein the prompt information is used to remind a user that an application corresponding to the image is forbidden.

32. A non-transitory computer-readable storage medium storing one or more programs, wherein the one or more programs comprise instructions, which, when executed by an electronic device with a display and one or more processors, cause the electronic device to:
display a home screen on the touchscreen, wherein the home screen comprises an icon of a first application;
detect a first touch operation on the icon of the first application;
display a first user interface of the first application in response to the first touch operation, wherein the first user interface comprises N graphical controls, a luminance value of each of N−M graphical controls other than the M graphical controls in the N graphical controls is a first luminance value, the first luminance value is less than a second luminance value, and the second luminance value is a luminance value of each of the N−M graphical controls in the first user interface, wherein M, N are natural numbers, and M is greater than or equal to 1 and less than N;
update the first user interface when detecting a temperature of the electronic device is less than or equal to a first preset temperature, wherein an updated first user interface comprises M graphical controls which has less than N graphical controls;
display a second user interface of the first application when the temperature of the electronic device is greater than the first preset temperature and less than or equal to a second preset temperature, wherein the second user interface has the N graphical controls, a first luminance value of N−M graphical controls other than the M graphical controls in the N graphical controls is less than a second luminance value, and the second luminance value is a luminance value of each of the N−M graphical controls in the first user interface;
display the first user interface when the temperature of the electronic device is greater than the second preset temperature;
display the updated first user interface instead of the first user interface when the temperature of the electronic device is greater than or equal to a third preset temperature, wherein the third preset temperature is greater than the second preset temperature.

33. The non-transitory computer-readable storage medium of claim 32, wherein the electronic device is further caused to: display a second user interface of the first application when the temperature of the electronic device is greater than a first preset temperature and less than or equal to a second preset temperature.

34. The non-transitory computer-readable storage medium of claim 32, wherein the electronic device is further caused to: skip displaying the first user interface and disabling the first application when the temperature of the electronic device is greater than or equal to a third preset temperature, wherein the third preset temperature is greater than the second preset temperature; and
display a third user interface, wherein the third user interface is a display interface of a currently running second application.

35. The non-transitory computer-readable storage medium of claim 32, wherein the electronic device is further caused to: skip displaying the first user interface and disabling the first application when the temperature of the electronic device is greater than or equal to a third preset temperature, wherein the third preset temperature is greater than the second preset temperature; and
display a third user interface, wherein the third user interface is a display interface of a currently running second application.

36. The non-transitory computer-readable storage medium of claim 32, wherein the first application is a camera application, the first user interface is a preview interface of the camera application, the preview interface has a graphical control of a portrait mode, and an updated preview interface does not have the graphical control of the portrait mode.

37. The non-transitory computer-readable storage medium of claim 32, wherein the first application is a chat application, the first user interface is a chat interface of the chat application, the chat interface has a video call graphical control, a voice call graphical control, and a photographing graphical control, and an updated chat interface does not have one or more of the video call graphical control, the voice call graphical control, and the photographing graphical control.

38. The non-transitory computer-readable storage medium of claim 32, wherein the electronic device is further caused to: display an icon or a text in a status bar in response to the updating of the first user interface, wherein the icon or the text is used to indicate that the temperature of the electronic device is less than or equal to the first preset temperature.
